(19) United States
(12) Patent Application Publication
(10) Pub. No.: US 2016/0241882 A1
(43) Pub. Date: Aug. 18, 2016

(54) IMAGE PROCESSING APPARATUS AND IMAGE PROCESSING METHOD

(71) Applicant: SONY CORPORATION, Tokyo (JP)

(72) Inventor: Kazushi Sato, Kanagawa (JP)

(21) Appl. No.: 15/023,132

(22) PCT Filed: Aug. 25, 2014
(86) PCT No.: PCT/JP2014/072194

§ 371 Date: Mar. 18, 2016

(30) Foreign Application Priority Data
Oct. 11, 2013 (JP) 2013-213726

(51) Int. Cl. H04N 19/82; H04N 19/117; H04N 19/33; H04N 19/172; H04N 19/187; H04N 19/59; H04N 19/159

(52) U.S. Cl. CPC H04N 19/82; H04N 19/59; H04N 19/117; H04N 19/159; H04N 19/172; H04N 19/187; H04N 19/33; H04N 19/70

(57) ABSTRACT

Provided is a mechanism capable of efficiently improving image quality when a definition of an image referred to between layers is enhanced. Provided is an image processing apparatus which includes an acquisition section configured to acquire a reference image used for encoding or decoding an image of a second layer having a different attribute from a first layer, the reference image being based on a decoded image of the first layer in which a plurality of blocks having different block sizes are set, a filtering section configured to apply a definition enhancement filter to the reference image acquired by the acquisition section and generate a definition-enhanced reference image, and a control section configured to control an application of the definition enhancement filter to each of the plurality of blocks by the filtering section according to a block size of each of the blocks.

### TECHNICAL FIELD

The present disclosure relates to an image processing apparatus and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H. 264/AVC (see. for example, “High Efficiency Video Coding (HEVC) text specification draft 10 (for FDIS & Consent)” by Benjamin Bross, Woo-Jin Han, Gary J. Sullivan, Jens-Rainer Ohm, Gory J. Sullivan, Ye-Kui Wang, and Thomas Wiegand, (JCTVC-L1003 v4. Jan. 14 to 23, 2013). HEVC provides not only coding of a single layer but also scalable video coding, as in known image coding schemes such as MPEG2 and AVC (Advanced Video Coding). An HEVC scalable video coding technology is also called SHVC (Scalable HEVC) (for example, see “Description of scalable video coding technology proposal by Qualcomm (configuration 2)” by Jianle Chen, el. al. (JCTVC-K0036, Oct. 10 to 19, 2012).

Incidentally, scalable video coding is generally a technology that hierarchically encodes a layer transmitting a rough image signal and a layer transmitting a fine image Signal. The scalable video coding is typically classified into three types of schemes, that is, a space scalability scheme, a time scalability scheme, and a signal to noise ratio (SNR) scalability scheme according to a hierarchized attribute. In the space scalability scheme, spatial resolutions (or image sizes) are hierarchized, and an image of a lower layer is op-sampled and then used for encoding or decoding an image of an upper layer, In the time scalability scheme, frame rates are hierarchized. In the SNR scalability scheme, SN ratios are hierarchized by changing coarseness of quantization. Though not yet adopted in the standard, a bit depth scalability scheme and a chroma format scalability scheme has-e been discussed as well.

In the scalable video coding, predicting an image of the upper layer using an image of the lower layer as a reference image is referred to as “inter-layer prediction.”Non-Patent Literature 2 proposes several techniques for the inter layer prediction In the inter-layer prediction in the enhancement layer, the prediction accuracy depends on the image quality of the image of the lower layer serving as the reference image. In this regard, Non-Patent Literature 3 proposes two techniques as techniques of representing a good gain for enhancing the image quality of the image of the lower layer The first technique is specifically described in Non-Patent Literature 4. and uses a cross color filter. In the first technique, the cross color filter is a sort of definition enhancement filter, and a definition of a chroma component is enhanced based on a neighboring luma component. The second technique is specifically described in Non- Patent Literature 5, and uses an edge enhancement filter.

### CITATION LIST

### Non-Patent Literature

Non-Patent Literature 1: Benjamin Bross, Woo-Jin Han, Gary J. Sullivan, Jens-Rainer Ohm, Gary J. Sullivan, Ye-Kui Wang, Thomas Wiegand, “High Efficiency Video Coding (HEVC) text specification draft 10 (for FDIS & Consent)” (JCTVC-1003_v4, Jan. 14 to 23, 2013)
Non-Patent Literature 2: Jianle Chen, el. al, “Description of scalable video coding technology proposal by Qualcomm (configuration 2)”(JCTVC-K0036, Oct. 10 to 19, 2012)
Non-Patent Literature 3: Jianle Chen, el. al, “Description of HEVC Scalable Extension Core Experiment SCE3: Inter-layer filtering” (JCTVC-N1103, Jul. 25 to Aug. 2, 2013)
Non-Patent Literature 4: Xiang Li, el. al, “Non-SCE3: Region based inter-layer Cross-Color Filtering” (JCTVC-N0229_r2, Jul. 25 to Aug. 2, 2013)
Non-Patent Literature 5: Sychev Maximi. et al, “Inner-layer prediction modes based on base layer sharpness filter” (JCTVC-N0070, Jul. 25 to Aug. 2, 2013)

### SUMMARY OF INVENTION

### Technical Problem

However, if the definition enhancement filter is applied to all pixels within an image, a filtering operation amount becomes enormous. Particularly, even when the definition enhancement filter is applied to a flat region including neither edge nor texture, the image quality is not particularly improved, and a demerit in which the operation amount is increased is large. On the other hand, if a configuration of the definition enhancement filter is adjusted for each individual block, the image quality is expected to be improved. However, when filter configuration information of each block is transmittal front an encoder to a decoder, a large code amount of the filter configuration information lowers coding efficiency.

It is an object of the technology of the present disclosure to provide an improved mechanism which is capable of solving or alleviating at least one of the above problems.

### Solution to Problem

According to the present disclosure, there is provided an image processing apparatus, including: an acquisition section configured to acquire a reference image used for encoding or decoding an image of a second layer having a different attribute from a first layer, the reference image being based on a decoded image of the first layer in which a plurality of blocks having different block sizes are set a filtering section configured to apply a definition enhancement filter to the reference image acquired by the acquisition section and generate a definition-enhanced reference image; and a control section configured to control an application of the definition enhancement filter to each of the plurality of blocks by the filtering section according to a block size of each of the blocks.

The image processing apparatus may be implemented as an image decoding device that decodes an image, or may be implemented as an image encoding device that encodes an image.

According to the present disclosure, there is provided an image processing method, including: acquiring a reference image used for encoding or decoding an image of a second layer having a different attribute from a first layer, the reference image being based on a decoded image of the first layer in which a plurality of blocks having different block sizes are set, applying a definition enhancement filter to the acquired reference image and generating a definition-enhanced reference image; and controlling an application of the definition enhancement filter to each of the plurality of blocks according to a block size of each of the blocks.

### Advantageous Effects of Invention

According to the technology of the present disclosure, it is possible to efficiently improve the image quality when enhancing a definition of an image referred to between layers.

The above effect is not necessarily limited, and effects described in this specification or other effects that can be understood from this specification may be obtained in addition to the above effect or instead of the above effect.

### BRIEF DESCRIPTION OF DRAWINGS

FIG. 1 is an explanatory view for describing a space scalability scheme.

FIG. 2 is an explanatory view for describing an SNR scalability scheme.

FIG. 3 is an explanatory view for describing a definition enhancement technique using a cross color filter.

FIG. 4 is an explanatory view for describing a definition enhancement technique using an edge enhancement filter

FIG. 5 is a block diagram showing a schematic configuration of an image encoding device.

FIG. 6 is a block diagram showing a schematic configuration of an image decoding device.

FIG. 7 is a block diagram showing an example of a configuration of an EL encoding section according to a first embodiment.

FIG. 8 is a block diagram showing an example of a detailed configuration of a definition enhancement section illustrated in FIG. 7.

FIG. 9A is a first explanatory view for describing an on/off operation of a definition enhancement filter according to a block size.

FIG. 9B is a second explanatory view for describing an on/off operation of a definition enhancement filter according to a block size.

FIG. 10 is a flowchart showing an example of a schematic process flow for encoding.

FIG. 11 is a flowchart showing an example of a process flow associated with definition enhancement of a reference image for encoding according to the first embodiment.

FIG. 12 is a block diagram showing an example of a configuration of an EL decoding sec don according to the first embodiment.

FIG. 13 is a block diagram showing an example of a detailed configuration of a definition enhancement section illustrated in FIG. 12.

FIG. 14 is a flowchart showing an example of a schematic process flow for decoding.

FIG. 15 is a flowchart showing an example of a process flow associated with definition enhancement of a reference image for decoding according to the first embodiment.

FIG. 16 is a block diagram showing an example of a configuration of an EL encoding section according to a second embodiment.

FIG. 17 is a block diagram showing an example of a detailed configuration of a definition enhancement section illustrated in FIG. 16.

FIG. 18 is an explanatory view for describing an example of a filter configuration depending on a block size.

FIG. 19 is an explanatory view for describing an example of predictive encoding of filter configuration information.

FIG. 20 is a flowchart showing an example of a process flow associated with definition enhancement of a reference image for encoding according to the second embodiment.

FIG. 21 is a block diagram showing an example of a configuration of an EL decoding section according to the second embodiment.

FIG. 22 is a block diagram showing an example of a detailed configuration of a definition enhancement section illustrated in FIG. 21.

FIG. 23 is a flowchart showing an example of a process flow associated with definition enhancement of a reference image for decoding according to the second embodiment.

FIG. 24 is a block diagram showing an example of a schematic configuration of a television.

FIG. 25 is a block diagram showing an example of a schematic configuration of a mobile phone.

FIG. 26 is a block diagram showing an example of a schematic configuration of a recording/reproduction device.

FIG. 27 is a block diagram showing an example of a schematic configuration of an image capturing device.

FIG. 28 is an explanatory view illustrating a first example of use of the scalable video coding.

FIG. 29 is an explanatory view illustrating a second example of use of the scalable video coding.

FIG. 30 is an explanatory view illustrating a third example of use of the scalable video coding.

FIG. 31 is an explanatory view illustrating a multi-view codec.

FIG. 32 is a block diagram showing 3 schematic configuration of the image encoding device for multi-view codec.

FIG. 33 is a block diagram showing a schematic configuration of the image decoding device for multi-view codec.

### DESCRIPTION OF EMBODIMENTS

Hereinafter, (a) preferred embodiments) of the present disclosure will be described in detail with reference to the appended drawings. In this specification and the drawings, elements that have substantially the same function and structure are denoted with the same reference signs, and repeated explanation is omitted.

Description will proceed in the following order.
1. Overview
1-1. Scalable Video Coding
1-2. Definition Enhancement of Reference Image
1-3. Basic Configuration Example of Encoder
1-4.Basic Configuration Example of Decoder
2. Configuration Example of EL Encoding Section (First Embodiment)
2-1.Overall Configuration
2-2. Configuration of Definition Enhancement Section
2-3.Process Flow
3. Configuration Example of EL Decoding Section (First Embodiment)
3-1.Overall Configuration
3-2. Configuration of Definition Enhancement Section
3-3.Process Flow
4. Configuration Example of EL Encoding Section (Second Embodiment)
4-1.Overall Configuration
4-2. Configuration of Definition Enhancement Section
4-3.Process Flow
5. Configuration Example of EL Decoding Section (Second Embodiment)
5-1.Overall Configuration
5-2. Configuration of Definition Enhancement Section
5-3.Process Flow
6. Example Application
6-1. Application to Various Products
6-2. Various Uses of Scalable Video Coding
6-3. Others
7. Conclusion

<1. Overview>

[1-1. Scalable Video Coding]

In the scalable video coding, a plurality of layers, each containing a series of images, is encoded. A base layer is a layer encoded first to represent roughest images. An encoded stream of the base layer may be independently decoded without decoding encoded streams of other layers, layers other than the base layer are layers called enhancement law representing finer images. Encoded streams of enhancement layers are encoded by using information contained in the encoded stream of the base layer. Therefore, to reproduce an image of an enhancement layer, encoded streams of both of the base layer and the enhancement layer are decoded. The number of layers handled in the scalable video coding may be any number equal to 2 or greater. When three layers or more are encoded, the lowest layer is the base layer and the remaining layers are enhancement layers. For an encoded stream of a higher enhancement layer, information contained in encoded streams of a lower enhancement layer and the base layer may be used for encoding and decoding.

(1) Space Scalability Scheme

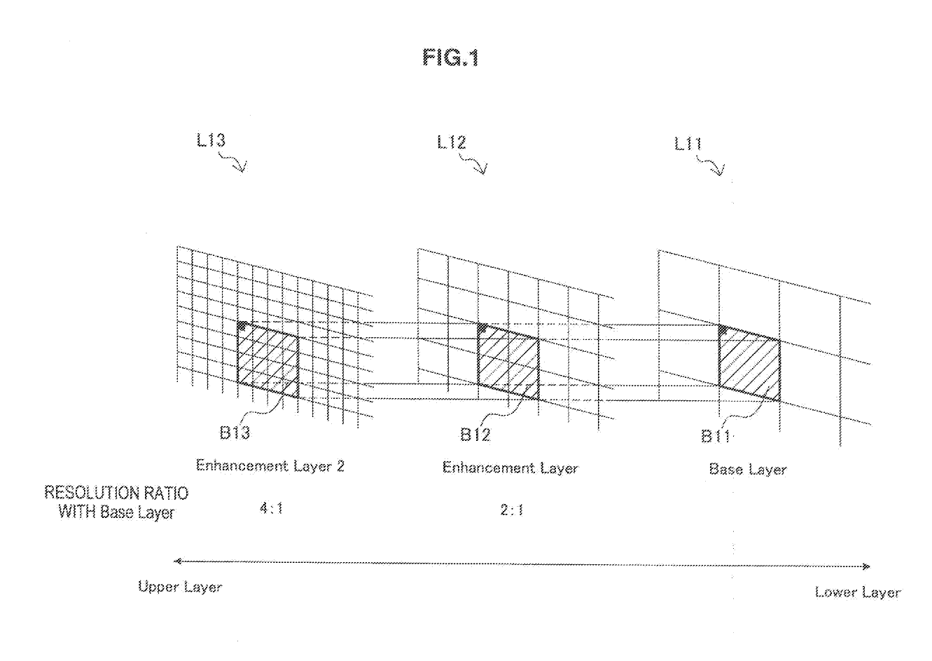

FIG. 1 is an explanatory view for describing a space scalability scheme. Referring to FIG. 1, three layers L11, L12, and L13 that undergo the scalable video coding according to the space scalability scheme are illustrated. The layer L11 is a base layer and the layers L12 and L13 are enhancement layers. A space resolution ratio of the layer L12 to the layer L11 is 2:1 and a space resolution ratio of the layer L13 to the layer L11 is 4:1. The resolution ratios herein are merely examples. For example, a resolution ratio of a non-integer such as 1.5:1 may be used. A block B11 of the layer L11 is a processing unit of an encoding process in a picture of the base layer. A block B12 of the layer L12 is a processing unit of an encoding process in a picture of the enhancement layer to which a common scene to the block B11 is projected. The block B12 corresponds to the block B11 of the layer L11. A block B13 of the layer L13 is a processing unit of an encoding process in a picture of the enhancement layer higher than the layers to which the common scene to the blocks B11 and B12 is projected. The block B13 corresponds to the block B11 of the layer L11 and the block B12 of the layer L12.

In the layer structure illustrated in FIG. 1, layers to which a common scene is projected are similar in the image texture. In other words, a block B11 in the layer L11, a block B12 in the layer L12, and a block B13 in the layer L13 are similar in the texture. Thus, for example, when pixels of the block B12 or the block B13 are predicted using the block B11 as a reference block, and pixels of the block B13 are predicted using the block B12 as the reference block, there is a possibility of high prediction accuracy being obtained. Such prediction between layers is referred to as “inter-layer prediction.” In intra BL prediction which is a sort of inter-layer prediction, a decoded image (reconstructed image) of the base layer is used as a reference image for predicting a decoded image of the enhancement layer. In intra residual prediction and inter residual prediction, a prediction error (residual) image of the base layer is used as a reference image for predicting a prediction error image of the enhancement layer. In the space scalability scheme, the spatial resolution of the enhancement layer is higher than the spatial resolution of the base layer. Thus, the image of the base layer is up-sampled according to the resolution ratio and used as the reference image. An up-sampling filter for the inter-layer prediction is typically designed similarly to an interpolation filter for motion compensation. The interpolation filter for the motion compensation includes 7 or 8 taps for the luma component and 4 taps for the chroma component.

(2) SNR Scalability Scheme

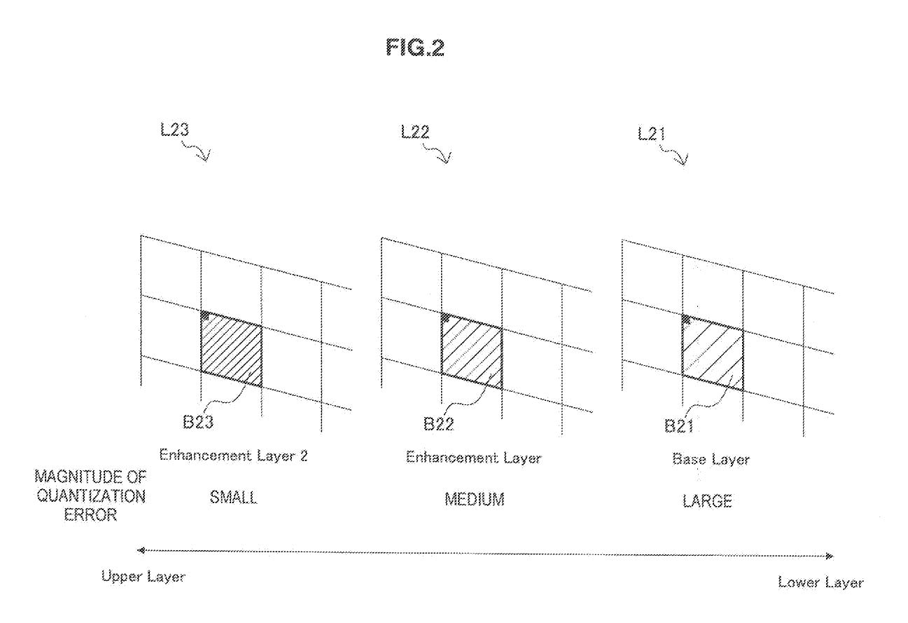

FIG. 2 is an explanatory view for describing the SNR scalability scheme. Referring to FIG. 2, three layers L21, L22 and L23 that undergo the scalable video coding according to the SNR scalability scheme are illustrated. The layer L21 is the base layer, and the layers L22 and L23 are the enhancement layers. The layer L21 is encoded to include only coarsest quantized data (data quantized by a latest quantization step) among the three layers. The layer L22 is encoded to include quantized data for compensating for a quantization error of the layer L21. Thus, when the layers L21 and L22 are decoded, it is possible to obtain a decoded image that is higher in definition (that is higher in the SN ratio) than when only the layer L21 is decoded. The layer L23 is encoded to include quantized data for further compensating for a quantization error of the layer L22. Thus, when the layers L21, L22 and L23 are decoded, it is possible to obtain a decoded image that is higher in definition. A block B21 of the layer L21 is a processing unit of an encoding process in a picture of the base layer. A block B22 of the layer L22 is a processing unit of an encoding process in a picture of the enhancement layer to which a common scene to the block B21 is projected. The block B22 corresponds to the block B21 of the layer L21. A block B23 of the layer L23 is a processing unit of an encoding process in a picture of the enhancement layer higher than the layers to which the common scene to the blocks B21 and B22 is projected. The block B23 corresponds to the block B21 of the layer 121 and the block B2 of the layer L22.

In the layer structure illustrated in FIG. 2, layers to which a common scene is projected are similar in the image texture. Thus, in the inter-layer prediction, for example, when pixels of the block B22 or the block B23 are predicted using the block B21 as the reference block or pixels of the block B23 are predicted using the block B22 as the reference block, there is a possibility of the high prediction accuracy being obtained. In a separate SNR scalability scheme, the spatial resolution of the enhancement layer is identical to the spatial resolution of the base layer. Thus, since the image of the base layer is used as the reference image, the up-sampling is unnecessary, When the space scalability scheme is combined with the SNR scalability scheme, the image of the base layer is up-sampled.

[1-2. Definition Enhancement of Reference Image]

In the inter-layer prediction, the prediction accuracy depends on the image quality of the reference image acquired from the base layer. In this regard, several techniques for enhancing the definition of the reference image before the prediction process have been proposed. One technique for representing a good gain is a technique using the cross color filter described in Non-Patent Literature 4. Another technique for representing a good gain is a technique using the edge enhancement filter described in Non-Patent Literature 5.

(1) Cross Color Filter of Chroma Component

FIG. 3 is an explanatory view for describing the definition enhancement technique using the cross color filter. The cross color filter proposed in Non-Patent Literature 4 uses 8 luma components P11 to P18 indicated by rectangular marks in FIG. 3 in addition to a chroma component P20 indicated by a circular mark in FIG. 3 as a filter tap in order to enhance the definition of one chroma component P20. An encoder side calculates a filter coefficient using the Wiener fiber separately for a Cb component and a Cr component so that a mean square error between an original image and a definition-enhanced image is minimized. The filter coefficient is calculated on each of one or more blocks having a uniform block size which is formed by dividing an image up to a certain depth. An optimal filter coefficient set of each block is encoded into an encoded stream. However, in the technique proposed in Non-Patent Literature 4, regardless of the depth to which the image is divided, the cross color filter is applied to all pixels in the image. Thus, a filtering operation amount is enormous. Further, when deep block division is performed, the code amount of the filter configuration information specifying the filter coefficient for each block is large.

(2) Edge Enhancement Filter

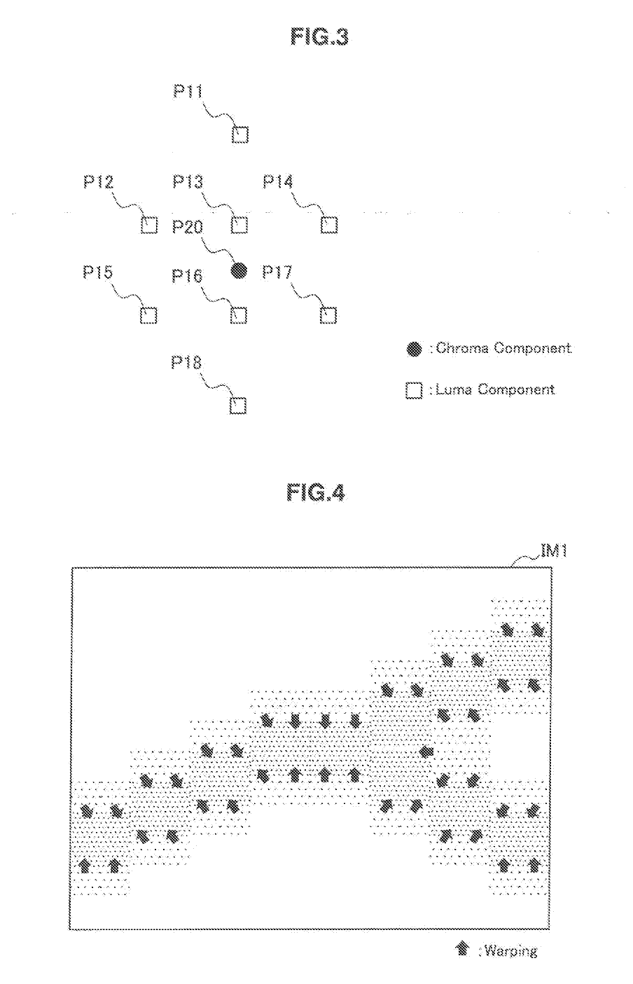

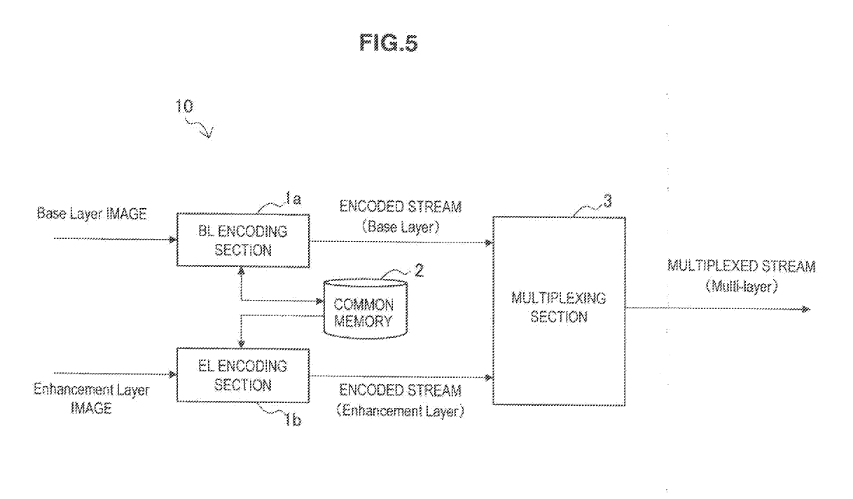

FIG. 4 is an explanatory view for describing the definition enhancement technique using the edge enhancement filter. According to the technique proposed in Non-Patent Literature 5, an edge map of the image of the base layer is extracted using the Prewitt filter, and a warping parameter calculated for each pixel based on the edge map is added to each pixel. As a result, the edge of the image of the base layer is enhanced. Referring to FIG. 4, a form in which a portion of an image IMI includes an edge and the edge is enhanced by a warping operation is symbolically expressed by a plurality of arrow icons. However, in the technique proposed in Non-Patent Literature 5, the edge map extraction and the warping operation are performed on all the pixels within the image. Thus, the filtering operation amount is enormous as well.

(3) Description of Problems

In various definition enhancement filters including the two examples described above, when a region including a complicated edge or texture is filtered, the effect of improving the image quality is large, but filtering a region including neither edge nor texture provides no particular improvement in the image quality. Thus, when it is desirable to reduce the operation amount, it is beneficial to control the definition enhancement filter adaptively for each region. However, when the filter configuration information is transmitted from the encoder to the decoder as in the technique proposed in Non-Patent Literature 4, if the filter configuration is changed for each individual block, the code amount of the filter configuration information becomes enormous, and the coding efficiency is likely to be lowered instead. Thus, there is a demand for a mechanism capable of improving the image quality adaptively without lowering the coding efficiency within the range of a realistic operation amount, in this regard, two exemplary embodiments providing such a mechanism will be described in detail later.

[1-3. Basic Configuration Example of Encoder]

FIG. 5 is a block diagram showing a schematic configuration of an image encoding device 10 supporting scalable video coding. Referring to FIG. 5, the image encoding device 10 includes a base layer (BL) encoding section 1a, an enhancement layer (EL) encoding section 1b, a common memory 2, and a multiplexing section 3.

The BL encoding section 1a encodes a base layer image to generate an encoded stream of the base layer. The EL encoding section 1b encodes an enhancement layer image to generate an encoded stream of an enhancement layer. The common memory 2 stores information commonly used between layers. The multiplexing section 3 multiplexes an encoded stream of the base layer generated by the BL encoding section 1a and an encoded stream of at least one enhancement layer generated by the EL encoding section 1b to generate a multilayer multiplexed stream.

[1-4. Basic Configuration Example of Decoder]

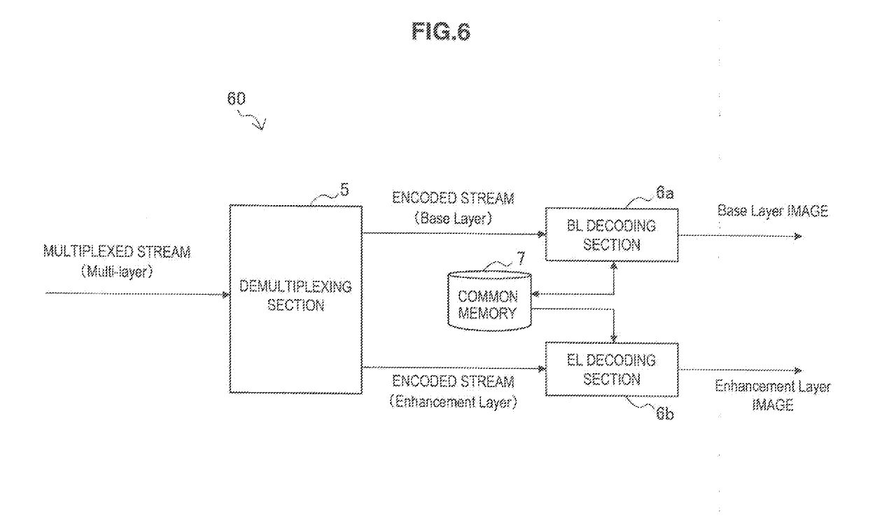

FIG. 6 is a block diagram showing a schematic configuration of an image decoding device 60 supporting scalable video coding. Referring to FIG. 6, the image decoding device 60 includes a demultiplexing section 5, a base layer (BL) decoding section 6a, an enhancement layer (EL) decoding section 6b, and a common memory 7.

The demultiplexing section 5 demultiplexes a multilayer multiplexed stream into an encoded stream of the base layer and an encoded stream of at least one enhancement layer. The BL decoding section 6a decodes a base layer image from an encoded stream of the base layer. The EL decoding section 6b decodes an enhancement layer image from an encoded stream of an enhancement layer. The common memory 7 stores information commonly used between layers.

In the image encoding device 10 illustrated in FIG. 5, the configuration of the BL encoding section 1a to encode the base layer and that of the EL encoding section 1b to encode an enhancement layer are similar to each other. Some parameters and images generated or acquired by the BL encoding section 1a may be buffered by using the common memory 2 and reused by the EL encoding section 1b. In the next section, some of embodiments of such a configuration of the EL encoding section 1b will be described.

Similarly, in the image decoding device 60 illustrated in FIG. 6, the configuration of the BL decoding section 6a to decode the base layer and that of the EL decoding section 6b to decode an enhancement layer are similar to each other. Some parameters and images generated or acquired by the BL decoding section 6a may be buffered by using the common memory 7 and reused by the EL decoding section 6b. Further in the next section, some of embodiments of such a configuration of the EL decoding section 6b will be described.

<2. Configuration Example of EL Encoding Section (First Embodiment)>

[2-1. Overall Configuration]

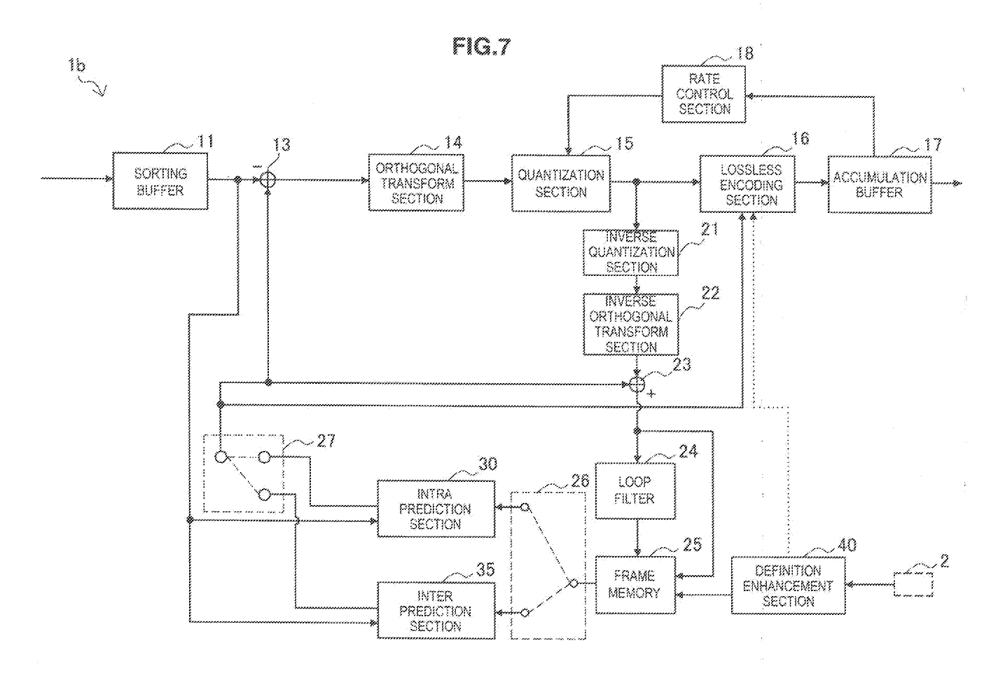

FIG. 7 is a block diagram showing an example of the configuration of the EL encoding section 1b according to the first embodiment. Referring to FIG. 7, the EL encoding section 1b includes a sorting buffer 11, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a loop filter 24, a frame memory 25, selectors 26 and 27, an intra prediction section 30, an inter prediction section 35, and a definition enhancement section 40.

The sorting buffer 11 sorts the images included in the series of image data. After sorting the images according to a GOP (Group of Pictures) structure according to the encoding process, the sorting butter 11 outputs the image data which has been sorted to the subtraction section 13, the intra prediction section 30 and the inter prediction section 35.

The image data input from the sorting buffer 11 and predicted image data input by the intra prediction section 30 or the inter prediction section 35 described later are supplied to the subtraction section 13. The subtraction section 13 calculates predicted error data which is a difference between the image data input from the sorting buffer 11 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (OCT) or Karhunen-Loeve transform, for example. In HEVC, an orthogonal transform is performed for each block called a transform unit (TU). The TU is a block formed by dividing a coding unit (CU) recursively, and the size of the TU is selected from 4×4 pixels, 8×8 pixels, 16×16 pixels, and 32×32 pixels. The orthogonal transform section 14 outputs transform coefficient data acquired by the orthogonal transform process to the quantization section 15.

The quantization section 15 is supplied with the transform coefficient data input from the orthogonal transform section 14 and a rate control signal from the rate control section 18 to be described below. The rate control signal specifies a quantization parameter for respective color components of each block. Typically, when the quantization parameter is large, a quantization error of transform coefficient data is also large. In the SNR scalability scheme, the quantization error of the enhancement layer is smaller than the quantization error of the base layer. The quantization section 15 quantizes the transform coefficient data with the quantization step depending on the quantization parameter (and the quantization matrix), and outputs the quantized transform coefficient data (hereinafter referred to as “quantized data”) to the lossless encoding section 16 and the inverse quantization section 21.

The lossless encoding section 16 performs a lossless encoding process on the quantized data input from the quantization section 15 to generate an encoded stream of an enhancement layer. The lossless encoding section 16 encodes various parameters referred to when the encoded stream is decoded and inserts the encoded parameters into a header region of the encoded stream, The parameter encoded by the lossless encoding section 16 can include information regarding intra prediction and information regarding inter prediction to be described below. Further, a parameter (hereinafter referred to as a “definition-enhancement-associated parameter”) associated with definition enhancement which is generated by the definition enhancement section 40 which will be described later may be encoded in the enhancement layer as well. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21, the inverse orthogonal transform section 22, and the addition section 23 form a local decoder. In the quantization step used by the quantization section 15, the inverse quantization section 21 performs inverse quantization on the quantized data of an enhancement layer to thereby restore the transform coefficient data. Then, the inverse quantization section 21 outputs the restored transform coefficient data to the inverse orthogonal transform section 22.

The inverse orthogonal transform section 22 performs an inverse orthogonal transform process on the transform coefficient data input from the inverse quantization section 21 to thereby restore the predicted error data. As in the orthogonal transform, the inverse orthogonal transform is performed for each TU. Then, the inverse orthogonal transform section 22 outputs the restored predicted error data to the addition section 23.

The addition section 23 adds the restored predicted error data input from the inverse orthogonal transform section 22 and the predicted image data input from the intra prediction section 30 or the inter prediction section 35 to thereby generate decoded image data (reconstructed image of the enhancement layer). Then, the addition section 23 outputs the generated decoded image data to the loop filter 24 and the frame memory 25.

The loop filter 24 includes a filter group for the purpose of improving image quality. A deblock filter (DF) is a filter that reduces block distortion occurring when an image is encoded. A sample adaptive offset (SAO) filter is a filter that adds an adaptively determined offset value to each pixel value. An adaptive loop filter (ALF) is a filter that minimizes an error between an image subjected to the SAO end an original image. The loop filter 24 filters the decoded image data input from the addition section 23 and outputs the filtered decoded image data to the frame memory IS.

The frame memory 25 stores the decoded image data of the enhancement layer input from the addition section 23, the filtered decoded image data of the enhancement layer input from the loop filter 24, and reference image data of the base layer input from the definition enhancement section 40 using a storage medium.

The selector 26 reads the decoded image data before the filtering used for the intra prediction from the frame memory 25 and supplies the read decoded image data as reference image data to the intra prediction section 30. Further, the selector 26 reads the filtered decoded image data used for the inter prediction from the frame memory 25 and supplies the read decoded image data as reference image data to the inter prediction section 35. When inter layer prediction is performed by the intra prediction section 30 or the inter prediction section 35, the selector 26 supplies the reference image data of the base layer to the intra prediction section 30 or the inter prediction section 35.

In the intra prediction mode, the selector 27 outputs predicted image data as a result of intra prediction output from the intra prediction section 30 to the subtraction section 13 and also outputs information about the intra prediction to the lossless encoding section 16. Further, in the inter prediction mode, the selector 27 outputs predicted image data as a result of inter prediction output from the inter prediction section 35 to the subtraction section 13 and also outputs information about the inter prediction to the lossless encoding section 16, The selector 27 switches the inter prediction mode and the intra prediction mode in accordance with the magnitude of a cost function value.

The intra prediction section 30 performs an intra prediction process on each prediction unit (PU) of HEVC based on the original image data and the decoded image data of the enhancement layer. The PU is a block formed by recursively dividing the CU, similarly to the TU. For example, the intra prediction section 30 evaluates a prediction result according to each candidate mode in a prediction mode set using a predetermined cost function. Next, the intra prediction section 30 selects a prediction mode in which a cost function value is the minimum, i.e., a prediction mode in which a compression ratio is the highest, as an optimum prediction mode. The intra prediction section 30 generates predicted image data of the enhancement layer according to the optimum prediction mode. The intra prediction section 30 outputs information regarding the intra prediction including prediction mode information indicating the selected optimum prediction mode, the cost function value, and the predicted image data to the selector 27.

The inter prediction section 35 performs an inter prediction process on each prediction unit (PU) of HEVC based on the original image data and the decoded image data of the enhancement layer. For example, the inter prediction section 35 evaluates a prediction result according to each candidate mode in a prediction mode set using a predetermined cost function. Next, the inter prediction section 35 selects a prediction mode in winch a cost function value is the minimum, i.e., a prediction mode in which a compression ratio is the highest, as an optimum prediction mode. The inter prediction section 35 generates predicted image data of the enhancement layer according to the optimum prediction mode. The inter prediction section 35 outputs information regarding the intra prediction including prediction mode information and motion information indicating the selected optimum prediction mode, the cost function value, and the predicted image data to the selector 27.

The definition enhancement section 40 acquires the image of the base layer buffered by the common memory 2 as the reference image, applies the definition enhancement filter to the acquired reference image, and generates a definition-enhanced reference image. The definition enhancement section 40 controls an application of the definition enhancement filter to the reference image according to the block size of the block set to the image of the base layer. More specifically, in the present embodiment, the definition enhancement section 40 invalidates an Application of the definition enhancement filter to a block having a block size larger than a threshold value. The definition enhancement section 40 also up-samples the reference image when the base layer and the enhancement layer differ in the spatial resolution. The definition-enhanced reference image generated by the definition enhancement section 40 may be stored in the frame memory 25 and referred to in the inter-layer prediction by the intra prediction section 50 or the inter prediction section 35. The definition-enhancement-associated parameter generated by the definition enhancement section 40 is encoded through the lossless encoding section 16.

[2-2. Configuration of Definition Enhancement Section]

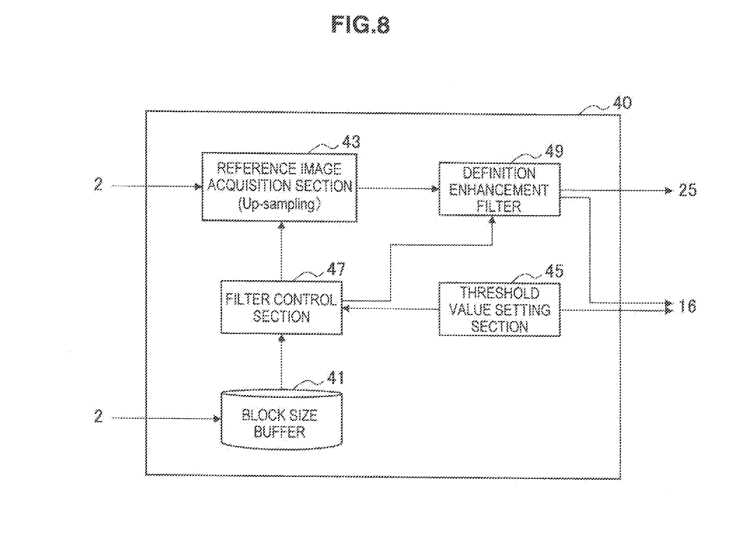

FIG. 8 is a block diagram showing an example of a detailed configuration of the definition enhancement section 40 illustrated in FIG. 7. Referring to FIG. 8, the definition enhancement section 40 includes a block size buffer 41, a reference image acquisition section 43, a threshold value setting section 45, a filter control section 47, and a definition enhancement filter 49.

(1) Block Size Buffer

The block size buffer 41 is a buffer that stores block size information specifying the block size of the block set to the base layer image. Here, the block may be a CU set as a processing unit of the encoding process for the base layer, a PU set as a processing unit of the prediction process, or a TU set as a processing unit of the orthogonal transform process. The CU is formed by hierarchically dividing each of a largest coding unit (ECU) arranged on each picture (or slice) in a taster scan order in a quad-tree form. Commonly, a plurality of CUs are set to one picture, and the CUs have various block sizes. For example, for a region (for example, a region including a plurality of edges or a complicated texture) in which a high-frequency component is strong within an image, the block division is deep, and thus the block size of each block is small. On the other hand, for a region (a flat region) in which a high-frequency component is weak within an image, the block division is shallow, and thus the block size of each block is large. This tendency appears not only for the CU but also for the PU and the TU.

The block size information for the CU includes, for example, LCU size information and division information. The LCU size information includes, for example, a parameter (log 2_min_luma_coding_block_size_minus3) specifying a size of a smallest coding unit (SCU) in the HEVC specification and a parameter (log 2_diff_max_min_luma_coding_block_size) specifying a difference between the SCU size and the LCU size. The division information includes a parameter (a set of a flag (split_cu_flag)) recursively specifying the presence or absence of block division from the LCU. The block size information for the PU includes information specifying block division into one or more PUs from the CU. The block size information for the TU includes information specifying block division into one or more TUs from the CU.

(2) Reference Image Acquisition Section

The reference image acquisition section 43 acquires the decoded image of the base layer buffered by the common memory 2 as the reference image for encoding the image of the enhancement layer. For example, when the enhancement layer is encoded according to the separate SNR scalability scheme, that is, when the spatial resolution of the base layer is identical to the spatial resolution of the enhancement layer, the reference image acquisition section 43 outputs the acquired reference image to the definition enhancement filter 49 without change. On the other hand, when the enhancement layer is encoded according to the space scalability scheme, that is, when the base layer has tower spatial resolution than the enhancement layer, the reference image acquisition section 43 up-samples the decoded image of the base layer according to the resolution ratio. Then, the reference image acquisition section 43 outputs the up-sampled decoded image of the base layer to the definition enhancement filter 49 as the reference image.

(3) Threshold Value Setting Section

The threshold value setting section 45 holds a setting of a determination threshold value that is compared with the block size in order to validate (turn on) or invalidate (turn off) an application of the definition enhancement filter 49. The determination threshold value may be set in arbitrary units such as video data, a sequence, or a picture. For example, when the CU size is used as the block size, the determination threshold value may have an arbitrary value included in a range from the SCU size to the LCU size. The determination threshold value may be fixedly defined in advance. Further, the determination threshold value may be selected in the encoder and encoded into an encoded stream. Further, the determination threshold value may be dynamically set as will be described later. When the determination threshold value is not known to the decoder (for example, not defined as a specification in advance), the threshold value setting section 45 generates threshold value information indicating a set determination threshold value. For example, the threshold value information may be represented by a form of a logarithm of the block size having 2 as its base. The threshold value information generated by the threshold value setting section 45 may be output to the lossless encoding section 16 as the definition-enhancement-associated parameter. Then, the threshold value information may be encoded through the lossless encoding section 16 and inserted into, for example, a video parameter set (VPS), 8 sequence parameter set (SPS), or a picture parameter set (PPS) of an encoded stream, or an extension thereof.

(4) Filter Control Section

The filter control section 47 controls the application of the definition enhancement filter to each of a plurality of blocks of the reference image according to the block size of each block. More specifically, in the present embodiment, the filter control section 47 validates the application of the definition enhancement filter 49 to the block having the block size smaller than the determination threshold value set by the threshold value setting section 45, and invalidates the application of the definition enhancement filter 49 to the block having the block size larger than the determination threshold value.

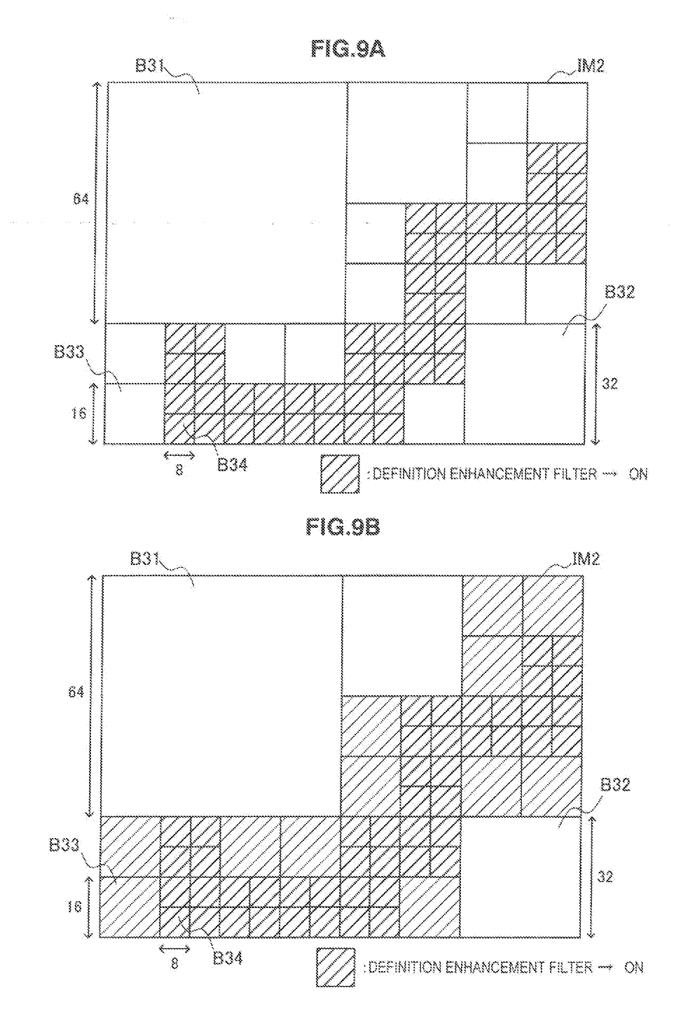

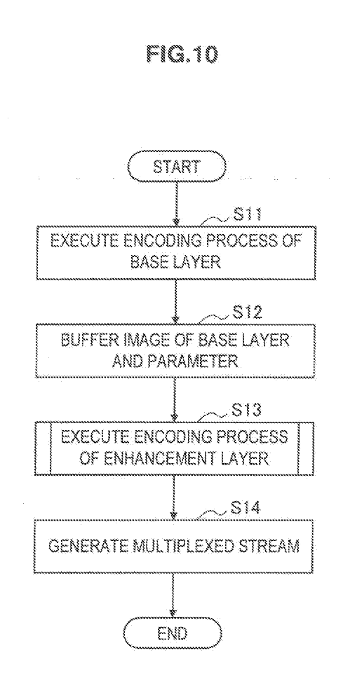

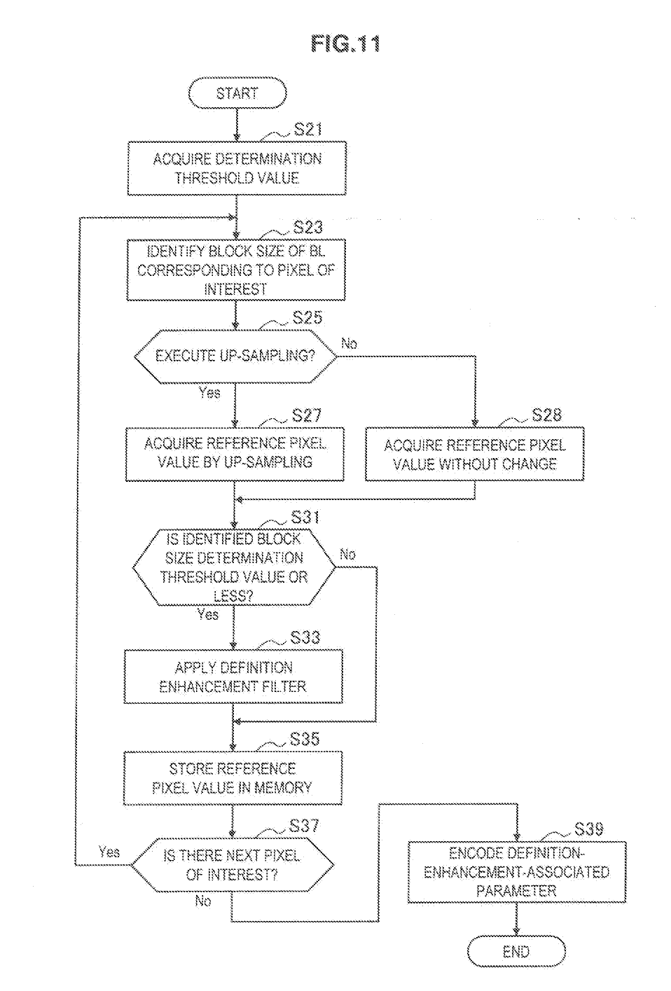

FIGS. 9A and 9B are explanatory views for describing an on/off operation of the definition enhancement filter according to the block size. A plurality of blocks including blocks B31, B32, B33, and B34 are set to an image IM2 illustrated in FIG. 9A. The size of the block B31 is 64×64 pixels. The size of the block B32 is 32×32 pixels. The size of the block B33 is 16×16 pixels. The size of the block B34 is 8×8 pixels. Here, for example, the determination threshold value is assumed to indicate 8 pixels, and the definition enhancement filter is assumed to be applied to the block having the block size equal to the determination threshold value. In this case, the filter control section 47 validates the application of the definition enhancement filter 49 to the blocks having the size of 8×8 pixels such as the block B34 as indicated by hatching in FIG. 9A. On the other hand, the filter control section 47 invalidates the application of the definition enhancement filter 49 to the blocks having the size of 64×64 pixels, 32×32 pixels, or 16×16 pixels such as the blocks B31, B32, and B33. Since the blocks having the large block size tend to be close to a flat region, by adaptively turning off the definition enhancement filter 49 as described above, it is possible to reduce the filtering operation amount without significant loss in the image quality. Further, it is possible to reduce the power consumption of the encoder and the decoder.

FIG. 9B illustrates the image IM2 again. Here, for example, the determination threshold value is assumed to indicate 16 pixels, and the definition enhancement filter is assumed to be applied to the blocks having the block size equal to the determination threshold value. In this case, the filter control section 47 validates the application of the definition enhancement filter 49 to the blocks having the size of 16×16 pixels or 8×8 pixels such as the blocks B33 and B34 as indicated by hatching in FIG. 9B. On the other hand, the filter control section 47 invalidates the application of the definition enhancement filler 49 to the blocks having the size of 64×64 pixels or 32×32 pixels such as the blocks B31 and B32.

For example, the filter control section 47 may decide the determination threshold value according to the spatial resolution ratio between the base layer and the enhancement layer. For example, when the resolution ratio is large, the edge and the texture of the image are likely to be blurred by the up-sampling. For this reason, when the resolution ratio is large, it is possible to appropriately enhance the definition of the edge and the texture that are blurred by setting the determination threshold value to be large and increasing the region to which the definition enhancement filter is applied.

(5) Definition Enhancement Filter

The definition enhancement filter 49 enhances the definition of the reference image used for encoding the image of the enhancement layer having an attribute (for example, the spatial resolution or the quantization error) different from the base layer under control of the filter control section 47. The definition enhancement fitter 49 may be, for example, the cross color filter proposed in Non-Patent Literature 4. In this case, the definition enhancement filter 49 performs the definition enhancement by filtering the chroma components of the reference image input from the reference image acquisition section 43 using the respective chroma components and a plurality of neighboring luma components as the filter tap. The filter coefficient may be calculated using the Wiener filter so that the mean square error between the original image and the definition-enhanced image is minimized. In this case, the definition enhancement filter 49 generates the filter configuration information indicating the calculated filter coefficient, and outputs the generated filter configuration information to the lossless encoding section 16 as the definition-enhancement-associated parameter. Further, the definition enhancement filter 49 may be the edge enhancement filter proposed in Non-Patent Literature 5. In this case, the definition enhancement filter 49 extracts the edge map of the reference image input from the reference image acquisition section 43 using the Prewitt filter, calculates the warping parameter for each pixel based on the edge map, and adds the calculated warping parameter to each pixel As a result, the edge of the reference image is enhanced. The application of the definition enhancement filter 49 to each pixel is controlled according to the block size of the block of the base layer corresponding to the corresponding pixel. The definition enhancement filter 49 outputs a pixel value that has undergone the definition enhancement for the pixel in which the application of the filter is validated. On the other hand, the definition enhancement filter 49 outputs a pixel value input from the reference image acquisition section 43 without change for the pixel in which the application of the filter is invalidated. The definition-enhanced reference image formed by the pixel values is stored in the frame memory 25.

[2-3. Process Flow]

(1) Schematic Flow

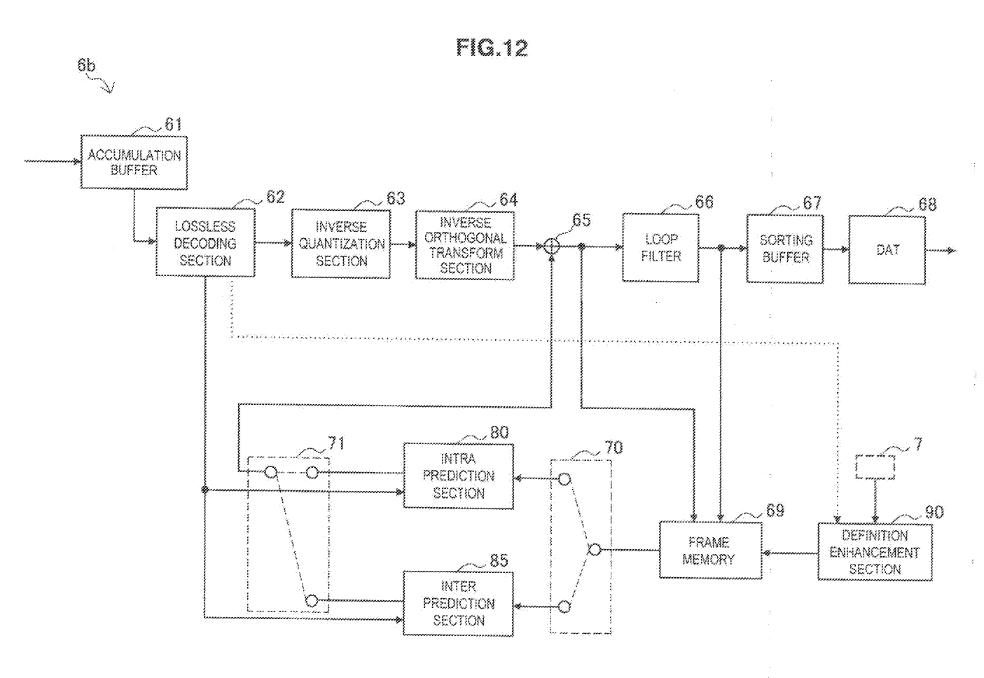

FIG. 10 is a flowchart showing an example of a schematic process flow for encoding. For the sake of simplicity of description, process steps that are not directly related to the technology of the present disclosure are omitted from FIG. 10.

Referring to FIG. 10, first, the BL encoding section 1a executes the encoding process of the base layer, and generates an encoded stream of the base layer (step S11).

The common memory 2 buffers the image of the base layer generated in the encoding process of the base layer and several parameters (for example, the resolution information and the block size information) (step S12).

Then, the EL encoding section 1b executes the encoding process of the enhancement layer, and generates an encoded stream of the enhancement layer (step (S13). In the encoding process of the enhancement layer executed here, the image of the base layer buttered by the common memory 2 undergoes the definition enhancement through the definition enhancement section 40 and is used as the reference image in the inter-layer prediction.

Then, the multiplexing section 3 multiplexes an encoded stream of the base layer generated by the BL encoding section 1a and an encoded stream of the enhancement layer generated by the EL encoding section 1b to generate a multilayer multiplexed stream (step S14).

(2) Definition-Enhancement-Associated process

FIG. 11 is a flowchart showing an example of a process flow associated with the definition enhancement of the reference image for encoding according to the first embodiment.

Referring to FIG. 11, first, the filter control section 47 acquires the determination threshold value set by the threshold value setting section 45 (step S21). A subsequent process is performed sequentially on the pixels (hereinafter referred to as “pixels of interest”) of the enhancement layer.

The fitter control section 47 identifies the block size of the base layer corresponding to a pixel of interest (step S23). Here, the identified block size is typically the size of the CU, the PU; or the TU of the base layer at a position corresponding to a pixel position of the pixel of interest in the enhancement layer.

Then, the filter control section 47 determines whether or not the up-sampling is to be executed based on the pixel position of the pixel of interest and the resolution ratio between the layers (step S25). When the filter control section 47 determines that the up-sampling is to be executed, the reference image acquisition section 43 applies the up-sampling filter to a group of pixels of the base layer buffered by the common memory 2, and acquires a reference pixel value of the pixel of interest (step S27). On the other hand, when the up-sampling is determined not to be executed, the reference image acquisition section 43 acquires the pixel value of the same position of the base layer buffered by the common memory 2 as the reference pixel value of the pixel of interest -without change (step S28).

Then, the filter control section 47 determines whether or not the identified block size is the determination threshold value or less (step S31). When the identified block size is larger than the determination threshold value, the filter control section 47 invalidate the application of the definition enhancement filter 49 to the pixel of interest On the other hand, when the block size corresponding to the pixel of interest is the determination threshold value or less, the definition enhancement filter 49 enhances the definition of the reference image by filtering the group of pixels acquired by the reference image acquisition, section 43 (step S33). Here, the filter operation may be an operation of the cross color filter or an operation of the edge enhancement filter,

Then, the definition enhancement filter 49 stores the reference pixel value of the pixel of interest configuring the definition-enhanced reference image in the frame, memory 25 (step S35). Thereafter, when there is a next pixel of interest the process returns to step S23 (step S37). On the other hand, when there is no next pixel of interest, the definition-enhancement-associated parameter that may include the threshold value information is encoded through the lossless encoding section 16 (step S39), and the process illustrated in FIG. 11 ends.

<3. Configuration Example of EL Decoding Section (First Embodiment)>

[3-1. Overall Configuration]

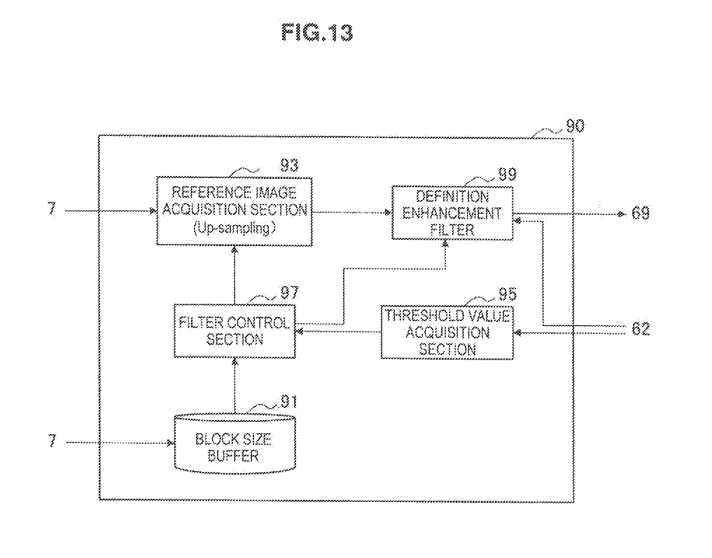

FIG. 12 is a block diagram showing an example of the configuration of the BL decoding section 6b according to the first embodiment. Referring to FIG. 12, the EL decoding section 6b includes an accumulation buffer 61, a lossless decoding section 62, an inverse quantization section 63, an inverse orthogonal transform section 64, an addition section 65, a loop filter 66, a sorting buffer 67, a digital-to-analog (D/A) conversion section 68, a frame memory 69, selectors 70 and 71, an intra prediction section 80, an inter prediction section 85, and a definition enhancement section 90.

The accumulation buffer 61 temporarily accumulates the encoded stream of the enhancement layer input from the demultiplexing section 5 using a storage medium.

The lossless decoding section 62 decodes the quantized data of the enhancement layer from the encoded stream of the enhancement layer input from the accumulation buffer 61 according to the encoding scheme used at the time of the encoding. The lossless decoding section 62 decodes the information inserted into the header region of the encoded stream. The information decoded by the lossless decoding section 62 can include, for example, the information regarding the intra prediction and the information regarding the inter prediction. The definition enhancement-associated parameter may also be decoded. The lossless decoding section 62 outputs the quantized data to the inverse quantization section 63. The lossless decoding section 62 outputs the information regarding the intra prediction to the intra prediction section 80. The lossless decoding section 62 outputs the information regarding the inter prediction to the inter prediction section 85. When the definition-enhancement-associated parameter has been decoded, the lossless decoding section 62 outputs the decoded definition-enhancement-associated parameter to the definition enhancement section 90.

The inverse quantization section 63 inversely quantizes the quantized data input from the lossless decoding section 62 in the quantization step (or the same quantization matrix) used at the time of the encoding to restore the transform coefficient data of the enhancement layer. The inverse quantization section 63 outputs the restored transform coefficient data 10 the inverse orthogonal transform section 64.

The inverse orthogonal transform section 64 performs an inverse orthogonal transform on the transform coefficient data input from the inverse quantization section 63 according to the orthogonal transform scheme used at the time of the encoding to generate the predicted error data. The inverse orthogonal transform is performed for each TU as described above. Then, the inverse orthogonal transform section 64 outputs the generated prediction error data to the addition section 65.

The addition section 65 adds the predicted error data input from the inverse orthogonal transform section 64 and the predicted image data input from the selector 71 to generate decoded image data. Then, the addition section 65 outputs the generated decoded image data to the loop filter 66 and the frame memory 69.

As in the loop filter 24 of the EL encoding section 1b, the loop filter 66 may include a deblock filter that reduces block distortion, a sample adaptive offset filter that adds an offset value to each pixel value, and an adaptive loop filter that minimizes an error with the original image. The loop filter 66 filters the decoded image data input from the addition section 65 and outputs the decoded image data after filtering to the sorting buffer 67 and the frame memory 69.

The sorting buffer 67 sorts the images input from the loop filter 66 to generate a chronological series of image data. Then, the sorting buffer 67 outputs the generated image data to the D/A conversion section 68.

The D/A conversion section 68 converts the image data with a digital format input from the sorting buffer 67 into an image signal with an analog format Then, the D/A conversion section 68 displays the image of the enhancement layer by outputting the analog image signal to, for example, a display (not shown) connected to the image decoding device 60.

The frame memory 69 stores the decoded image data before the filtering input from the addition section 65, the decoded image data after the filtering input from the loop filter 66, and the reference image date of the base layer input from the definition enhancement section 90 using a storage medium.

The selector 70 switches an output destination of the image data from the frame memory 69 between the intra prediction section 80 and the inter prediction section 85 for each block in the image according to the mode information acquired by the lossless decoding section 62. For example, when the intra prediction mode is designated, the selector 70 outputs the decoded image data before the filtering supplied from the frame memory 69 as the reference image date to the intra prediction section 80. When the inter prediction mode is designated, the selector 70 outputs the decoded image data after the filtering as the reference image data to the inter prediction section 85. When the inter layer prediction is performed in the intra prediction section 80 or the inter prediction section 85, the selector 70 supplies the reference image data (the definition-enhanced reference image) of the base layer to the intra prediction section SO or the inter prediction section 85.

The selector 71 switches an output source of the predicted image data to be supplied to the addition section 65 between the intra prediction section 80 and the inter prediction section 85 according to the mode information acquired by the lossless decoding section 62. For example, when the intra prediction mode is designated, the selector 71 supplies the predicted image date output from the intra prediction section 80 to the addition section 65. When the inter prediction mode is designated, the selector 71 supplies the predicted image data output from the inter prediction section 85 to the addition section 65.

The intra prediction section 80 performs the intra prediction process of the enhancement layer based on the information related to the intra prediction input from the lossless decoding section 62 and the reference image data from the frame memory 69, and generates the predicted image data. The intra prediction process is executed in units of PUs. When a mode corresponding to the inter-layer prediction is designated as the intra prediction mode, the intra prediction section 80 refers to the reference image data of the base layer. The intra prediction section 80 outputs the generated predicted image data of the enhancement layer to the selector 71.

The inter prediction section 85 performs the inter prediction process (the motion compensation process) of the enhancement layer based on information related to the inter prediction input from the lossless decoding section 62 and the reference image data from the frame memory 69, and generates the predicted image data. The inter prediction process is executed in units of PUs. When a mode corresponding to the inter-layer prediction is designated as the inter prediction mode, the inter prediction section 85 refers to the reference image data of the base layer. The inter prediction section 85 outputs the generated predicted image data of the enhancement layer to the selector 71.

The definition enhancement section 90 acquires the image of the base layer buffered by the common memory 7 as the reference image, applies the definition enhancement filter to the acquired reference image, and generates the definition-enhanced reference image. The definition enhancement section 90 controls the application of the definition enhancement filter to the reference image according to the block size of the block set to the image of the base layer. More specifically, in the present embodiment, the definition enhancement section 90 invalidates the application of the definition enhancement filter to the block having the block size larger than the threshold value. The definition enhancement section 90 also up-samples the reference image when the base layer and the enhancement layer differ in the spatial resolution. The definition-enhanced reference image generated by the definition enhancement section 90 may be stored in the frame memory 69 and may be used as the reference image in the inter-layer prediction by the intra prediction section 80 or the inter prediction section 85. The definition enhancement section 90 may control the definition enhancement process according to the definition-enhancement-associated parameter decoded from the encoded stream.

[3-2. Configuration of Definition Enhancement Section]

FIG. 13 is a block diagram showing an example of a detailed configuration of the definition enhancement section 90 illustrated in FIG. 12. Referring to FIG. 13, the definition enhancement section 90 includes a block size buffer 91, a reference image acquisition section 93, a threshold value acquisition section 95, a filter control section 97, and a definition enhancement filter 99.

(1) Block Size Buffer

The block size buffer 91 is a buffer that stores the block size information specifying the block size of the block set to the base layer image. Here, the block may be a CU set as a processing unit of the decoding process for the base layer, a PU set as a processing unit of the prediction process, or a TU set as a processing unit of the orthogonal transform process. The block size information for the CU includes, for example, LCU size information and division information. The block size information for the PU includes information specifying block division into one or more PUs from the CU. The block size information for the TU includes information specifying block division into one or more TUs from the CU.

(2) Reference Image Acquisition Section

The reference image acquisition section 93 acquires the decoded image of the base layer buffered by five common memory 7 as the reference image for decoding the image of the enhancement layer. For example, when the enhancement layer is decoded according to the separate SNR scalability scheme, that is, when the spatial resolution of the base layer is identical to the spatial resolution of the enhancement layer, the reference image acquisition section 93 outputs the acquired reference image to the definition enhancement filter 99 without change. On the other hand, when the enhancement layer is decoded according to the space scalability scheme, that is, when the base layer has lower spatial resolution than the enhancement layer, the reference image acquisition section 93 up-samples the decoded image of the base layer according to the resolution ratio. Then, the reference image acquisition section 93 outputs the up-sampled decoded image of the base layer to the definition enhancement filter 99 as the reference image.

(3) Threshold Value Acquisition Section

The threshold value acquisition section 95 acquires the determination threshold value that is compared with the block size in order to validate or invalidate the application of the definition enhancement filler 99. The determination threshold value may be acquired in arbitrary units such as video data, a sequence, or a picture. For example, the determination threshold value may be fixedly defined in advance. Instead, when the determination threshold value is selected in the encoder, the definition-enhancement-associated parameter may be decoded from the VPS, the SPS, or the PPS of the encoded stream through the lossless decoding section 62. The definition-enhancement-associated parameter includes the threshold value information indicating the determination threshold value to be used by the decoder. The threshold value acquisition section 95 may acquire the threshold value information. The determination threshold value may be dynamically set depending on the resolution ratio between the layers as described above.

(4) Filter Control Section

The filter control section 97 controls the application of the definition enhancement filter to each of a plurality of blocks of the reference image according to the block size of each block. More specifically, in the present embodiment, the filter control section 97 validates the application of the definition enhancement filter 99 to the block having the block size smaller than the determination threshold value acquired by the threshold value acquisition section 95, and invalidates the application of the definition enhancement filter 99 to the block having the block size larger than the determination threshold value. For example, the filter control section 97 may decide the determination threshold value depending on the spatial resolution ratio between the base layer and the enhancement layer.

(5) Definition Enhancement Filter

The definition enhancement filter 99 enhances the definition of the reference image used for decoding the image of the enhancement layer having an attribute different from the base layer under control of the filter control section 97. The definition enhancement filter 99 may be, for example, the cross color filter proposed in Non-Patent literature 4. In this case, the definition enhancement filter 99 performs the definition enhancement by filtering the chroma components of the reference image input from the reference image acquisition section 93 using the respective chroma components and a plurality of neighboring luma components as the filter tap. At the encoder side, the filter coefficient may be calculated using the Wiener filter and specified by the filler configuration information included in the definition-enhancement-associated parameter. Further, the definition enhancement filter 99 may be the edge enhancement filter proposed in Non-Patent Literature 5. In this case, the definition enhancement filter 99 extracts the edge map of the reference image input from the reference image acquisition section 93 using the Prewitt filter, calculates the warping parameter for each pixel based on the edge map, and adds the calculated warping parameter to each pixel. As a result, the edge of the reference image is enhanced. The application of the definition enhancement filter 99 to each pixel is controlled according to the block size of the block of the base layer corresponding to the corresponding pixel. The definition enhancement filter 99 outputs a pixel value that has undergone the definition enhancement for the pixel in which the application of the filter is validated. On the other hand, the definition enhancement filter 99 outputs a pixel value input from the reference image acquisition section 93 without change for the pixel in which the application of the filter is invalidated. The definition-enhanced reference image formed by the pixel values is stored in the frame memory 69.

[3-3. Process Flow for Encoding]

(1) Schematic Flow

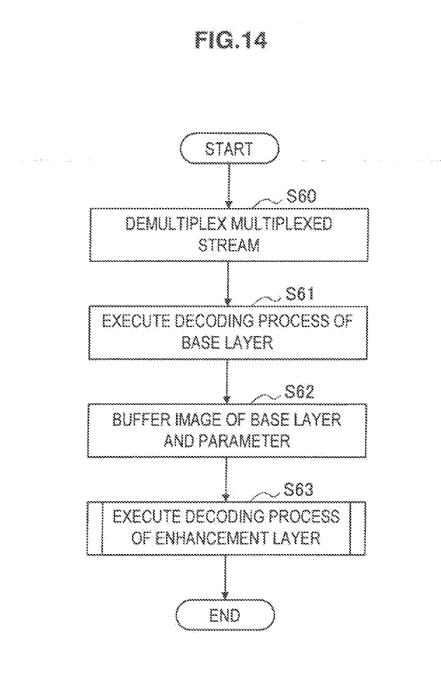

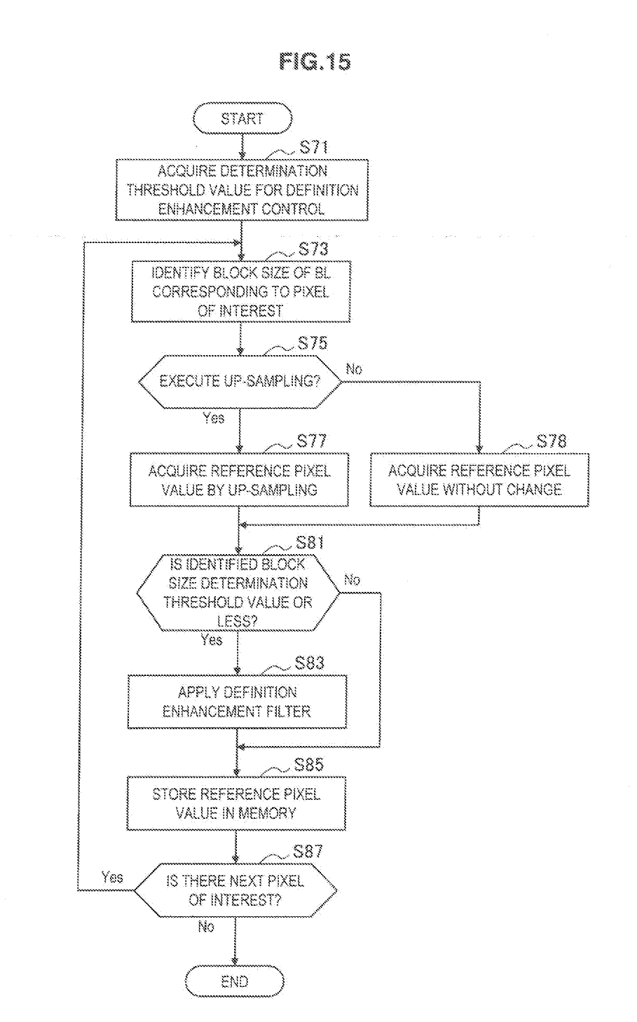

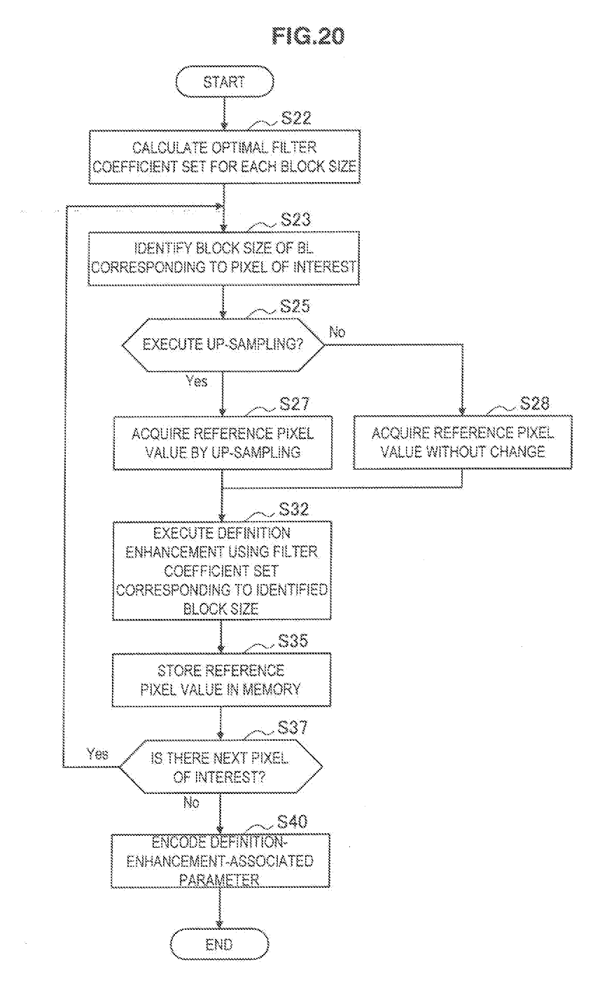

FIG. 14 is a flow chart showing an example of a schematic process flow tor decoding. For the sake of brevity of description, process steps that are not directly related to technology according to the present disclosure are omitted from FIG. 20.

Referring to FIG. 14, the demultiplexing section 5 first demultiplexes the multilayer multiplexed stream into the encoded stream of the base layer and the encoded stream of the enhancement layer (step S60).

Next, the BL decoding section 6a performs the decoding process of the base layer to reconstruct the image of the base layer from the encoded steam of the base layer (step S61).

The common memory 7 buffers the image of the base layer generated in the decoding process of the base layer and several parameters (for example, the resolution information and the block size information) (step S62).

Then, the EL decoding section 6b executes the decoding process of the enhancement layer, and reconstructs the enhancement layer image (step S63). In the decoding process of the enhancement layer executed here, the image of the base layer buttered by the common memory 7 undergoes the definition enhancement through the definition enhancement section 90 and is used as the reference image in the inter-layer prediction.

(2) Definition-Enhancement-Associated Process

FIG. 15 is a flowchart showing an example of a process flow associated with the definition enhancement of the reference image for decoding according to the first embodiment.

Referring to FIG. 15, first, the threshold value acquisition section 95 acquires the determination threshold value used for control of the definition enhancement (step S71). The determination threshold value may be acquired from a memory that stores a previously defined parameter or may be acquired from the definition-enhancement-associated parameter decoded by the lossless decoding section 62. A subsequent process is performed sequentially on the pixels of interest of the enhancement layer.

The filter control section 97 identifies the block size corresponding to a pixel of interest of the base layer (step S73). Here, the identified block size is typically the size of the CU, the PU, or the TU of the base layer at a position corresponding to a pixel position of the pixel of interest in the enhancement layer.

Then, the filter control section 97 determines whether or not the up-sampling is to be executed based on the pixel position of the pixel of interest and the resolution ratio between the layers (step S75). When the filter control section 97 determines that the up-sampling is to be executed, the reference image acquisition section 93 applies the up-sampling filter to a group of pixels of the base layer buffered by the common memory 7, and acquires a reference pixel value of the pixel of interest (step S77). On the other hand, when the up-sampling is determined not to be executed, the reference image acquisition section 93 acquires the pixel value of the same position of the base layer buffered by the common memory 7 as the reference pixel value of the pixel of interest without change (step S78).

Then, the filter control section 97 determines whether or not the identified block size is the determination threshold value or less (step S81). When the identified block size is larger than the determination threshold value, the filter control section 97 invalidates the application of the definition enhancement filter 99 to the pixel of interest. On the other band, when the block size corresponding to the pixel of interest is the determination threshold value or less, the definition enhancement filter 99 enhances the definition of the reference image by filtering the group of pixels acquired by the reference image acquisition section 93 (step S83). Here, the filter operation may be an operation of the cross color filter or an operation of the edge enhancement filter.

Then, the definition enhancement filter 99 stores the reference pixel value of the pixel of interest configuring the definition-enhanced reference image m the frame memory 69 (step S85). Thereafter, when there is a next pixel of interest, the process returns to step S73 (step S87). On the other hand, when there is no next pixel of interest, the process illustrated in FIG. 15 ends.

<4. Configuration Example of EL Encoding Section (Second Embodiment)>

[4-1. Overall Configuration]

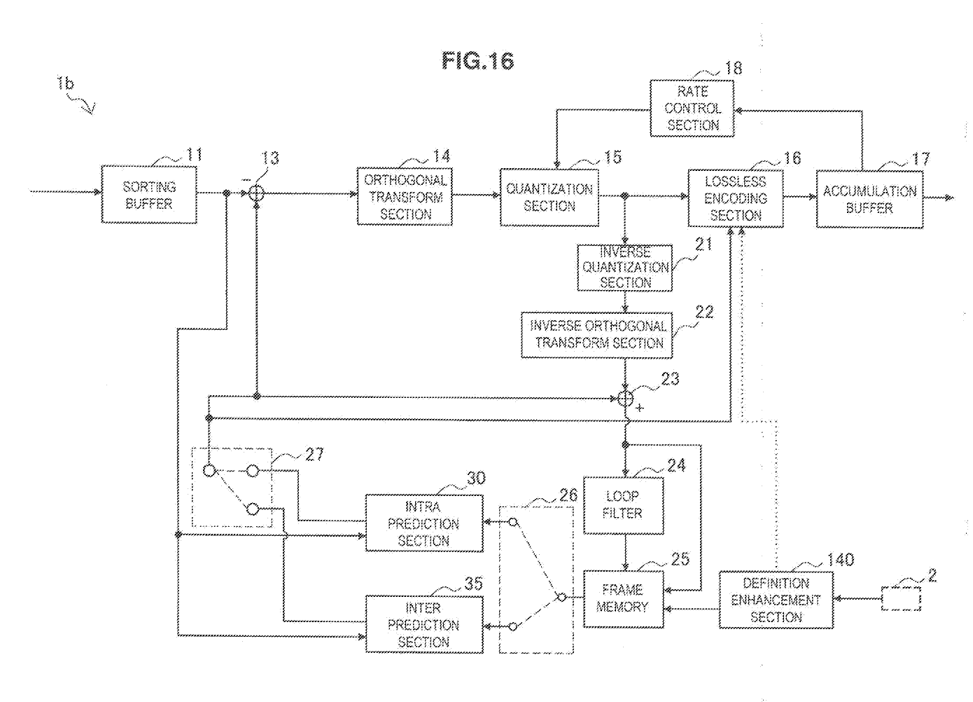

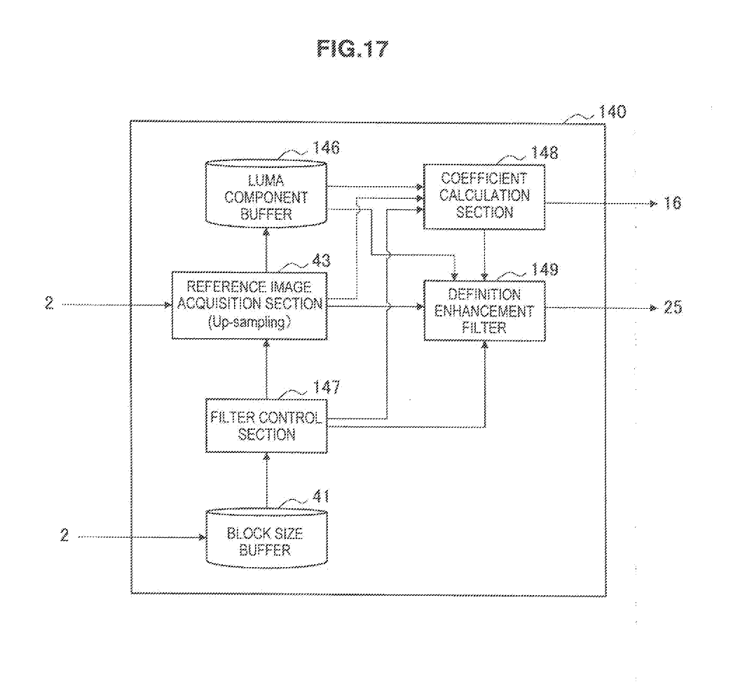

FIG. 16 is a block diagram showing an example of a configuration of an EL encoding section 1b according to a second embodiment. Referring to FIG. 16, the EL encoding section 1b includes a sorting buffer 11, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a loop filter 24, a frame memory 25, selectors 26 and 27, an intra prediction section 30, an inter prediction section 35, and a definition enhancement section 140.

The definition enhancement section 140 acquires the image of the base layer buffered by the common memory 2 as the reference image, applies the definition enhancement filter to the acquired reference image, and generates a definition-enhanced reference image. The definition enhancement section 140 controls an application of the definition enhancement filter to the reference image according to the block size of the block set to the image of the base layer. More specifically, in the present embodiment, the definition enhancement section 140 decides a filter configuration of the definition enhancement filter applied to each block depending on the block size of the block. The definition enhancement section 140 also up-samples the reference image when the spatial resolution of the base layer is different from the spatial resolution of the enhancement layer. The definition-enhanced reference image generated by the definition enhancement section 140 may be stored in the frame memory 25 and referred to in the inter-layer prediction by the intra prediction section 30 or the inter prediction section 35. The definition-enhancement-associated parameter generated by the definition enhancement section 140 is encoded through the lossless encoding section 16.

[4-2. Configuration of Definition Enhancement Section]

FIG. 17 is a block diagram showing an example of a detailed configuration of the definition enhancement section 140 illustrated in FIG. 16. Referring to FIG. 17, the definition enhancement section 140 includes a block size buffer 41, a reference image acquisition section 43, a luma component buffer 146, a filter control section 147, a coefficient calculation section 148, and a definition enhancement filter 149.

(1) Luma Component Buffer

The luma component buffer 146 is a buffer that temporarily stores the reference image of the luma component acquired (up-sampled as necessary) by the reference image acquisition section 43. The reference image of the luma component stored by the luma component buffer 146 may be used in calculation of the filter coefficient of the cross color fiber by the coefficient calculation section 148 and the filter operation by live definition enhancement filter 149.

(2) Filter Control Section

The filter control section 147 controls the application of the definition enhancement filter to each of a plurality of blocks of the reference image according to the block size of each block. More specifically, in the present embodiment, the filter control section 147 decides the filter configuration of the definition enhancement filter 149 applied to each block depending on the block size of the block. For example, the filter control section 147 causes the coefficient calculation section 148 to calculate the optimal filter coefficient of the cross color filter for blocks having the same block size within a picture or a slice. As a result, one optimal filter coefficient set is calculated for each block size candidate (for example, three sets of optimal filter coefficients ate derived when the block size is 8×8 pixels, 16×16 pixels, or 32×32 pixels). Then, when the definition enhancement filter 149 is applied to each block, the filter control section 147 causes the definition enhancement filter 149 to use the calculated filter coefficient set corresponding to the block size of the block.

(3) Coefficient Calculation Section

The coefficient calculation section 148 calculates the optimal filter coefficient set of the cross color filter applied to the chroma component of the reference image for each block size candidate using the luma component and the chroma component of one or more blocks having the block size. The filter tap of the cross color filter includes the chroma components and a plurality of neighboring luma components. The optimal filter coefficient set may be calculated using the Wiener filter so that the mean square error between the original image and the definition-enhanced image of the chroma component is minimized. Here, one or more blocks may be ail blocks having the same block size within a picture or a slice or some blocks having the same block size within a picture or a slice.

FIG. 18 is an explanatory view for describing an example of the filler configuration depending on the block size. A plurality of blocks including blocks B41, B42a, B42b, B43, and B44 are set to an image IM3 illustrated in FIG. 18. The size of the block B41 is 64×64 pixels. The size of the blocks B42a and B42b is 32×32 pixels. The size of the block B43 is 16×16 pixels. The size of the block B44 is 8×8 pixels. First, for example, the coefficient calculation section 148 calculates a coefficient set FC₆₄ so that the mean square error between the original image and the definition-enhanced image of the chroma component of the block B41 is minimized. Then, the coefficient calculation section 148 calculates a coefficient set FC₃₂ so that the mean square errors between the original image and the definition-enhanced image of the chroma components of the blocks B42a and B42b are minimized. Then, the coefficient calculation section 148 calculates a coefficient set FC₁₆ so that the mean square errors between the original image and the definition-enhanced image of the chroma components of a plurality of blocks of 16×16 pixels including the block B43 are minimized. Then, the coefficient calculation section 148 calculates a coefficient set FC₈ so that the mean square errors between the original image and the definition-enhanced image of the chroma components of a plurality of blocks of 8×8 pixels including the block B44 are minimized. As the filter coefficient set that can be used in common for the same block size is calculated, it is possible to reduce the code amount of the filter configuration information for transmission of the filter coefficient to the decoder. Further, the filter coefficient set may be derived in view of a correlation between the block size and the strength of the high-frequency component such that the filter strength is increased for a block that is stronger (smaller) in the high-frequency component, and the filter strength is decreased for a block that is weaker (larger) in the high-frequency component Thus, the image quality is more effectively improved than when the single filter coefficient is used.

The coefficient calculation section 148 outputs the calculated filter coefficient set to the definition enhancement filter 149 for each block size. Further, the coefficient calculation section 148 generates the filter configuration information indicating the filter coefficient set. The filter configuration information indicates the filter configuration to be used by the definition enhancement filter in the decoder within a range of an available block size. For example, when the CU size is used as the block size, the SCU size is pixels, and the LCU size is 32×32 pixels, the coefficient calculation section 148 may omit calculation of the filter coefficient set corresponding to the block size of 64×64 pixels and generation of the filter configuration information. Then, the coefficient calculation section 148 outputs the generated filter configuration information to the lossless encoding section 16 as the definition-enhancement-associated parameter. The filter configuration information may be encoded by the lossless encoding section 16 and inserted into, for example, the VPS, the SPS, or the PPS of the encoded stream or the extension thereof.

The coefficient calculation section 148 may perform predictive encoding on the filter configuration information between the pictures. Further, the coefficient calculation section 148 may perform predictive encoding on the filter configuration information between different block sizes. Further, the coefficient calculation section 148 may perform predictive encoding on the filter configuration information between different color components (for example, from the Cb component to the Cr component or vice versa). As a result, it is possible to further reduce the code amount of the filter configuration information.

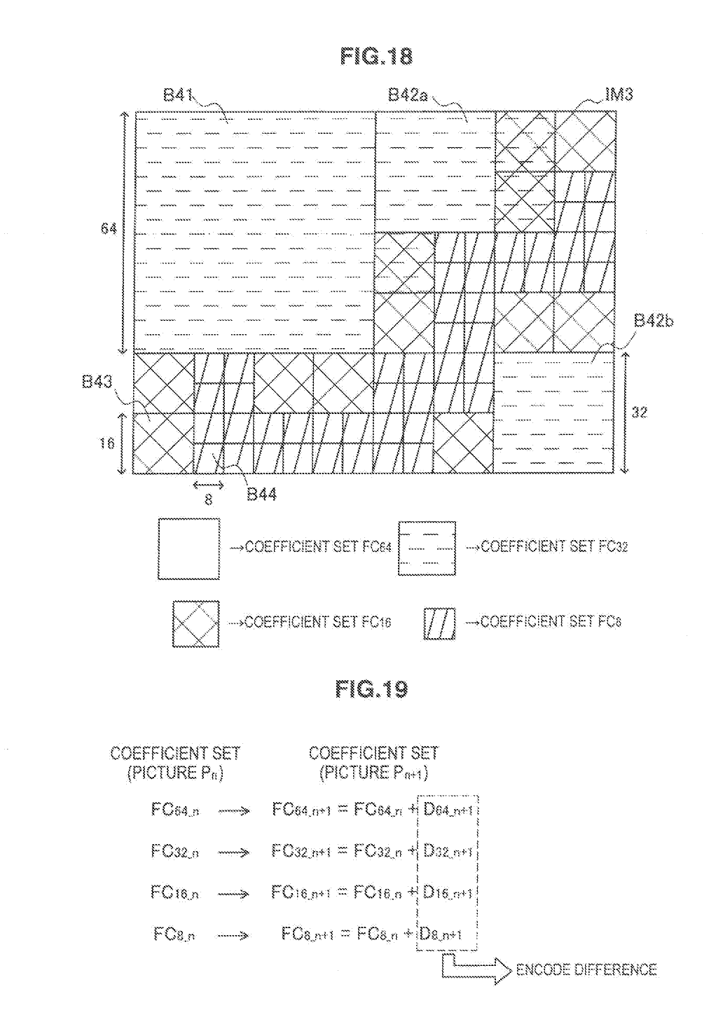

FIG. 19 is an explanatory view for describing an example of the predictive encoding for the filter configuration information. On the left in FIG. 19, filter coefficient sets FC₆₄_{_}ₙ, FC₃₂_{_}ₙ, FC₁₆_{_}ₙ and FC₈_{_}ₙ calculated for four block sizes when an n-th picture Pₙ is encoded are illustrated. The coefficient calculation section 148 calculates a filter coefficient set FC₆₄_{_}ₙ and then further calculates a filter coefficient difference set D₆₄_{_}ₙ₋₁(=FC₆₄_{_}ₙ₊₁-FC₆₄_{_}ₙ) when an (n+1)-th picture Pₙ₊₁ is encoded. Similarly, the coefficient calculation section 148 also calculates filter coefficient difference sets D₃₂_{_}ₙ, D₁₆_{_}ₙ₊₁,and D₈_{_}ₙ₊₁ corresponding to the filter coefficient sets FC₃₂_{_}ₙ₊₁, FC₁₆_{_}ₙ₊₁ and FC₈_{_}ₙ₊₁. Typically, since the optimal filter coefficient does not significantly change between the pictures, a range of a value of the filter coefficient difference set is smaller than a range of a value of the filter coefficient set. For this reason, as the filter coefficient difference set is encoded, the code amount of the filter configuration information can be reduced.

(4) Definition Enhancement Filter

The definition enhancement filter 149 enhances the definition of the reference image used for encoding the image of the enhancement layer having an attribute (for example, the spatial resolution or the quantization error) different from the base layer under control of the filter control section 147. In the present embodiment, the definition enhancement filter 149 may be, for example, the cross color filter proposed in Non-Patent Literature 4. In this case, the definition enhancement filter 149 performs the definition enhancement by filtering the chroma components of the reference image input from the reference image acquisition section 43 using the respective chroma components and a plurality of neighboring luma components as the filter tap. The definition enhancement filter 149 uses a set corresponding to the block size identified by the filter control section 147 among a plurality of filter coefficient sets input from the coefficient calculation section 148. Then, the definition enhancement filter 149 stores the definition-enhanced reference image in the frame memory 25.

[4-3. Process Flow]

A schematic process flow for encoding according to the present embodiment may be the same as the flow described above with reference to FIG. 20. FIG. 20 is a flowchart showing an example of a process flow associated with the definition enhancement of the reference image for encoding according to the present embodiment.

Referring to FIG. 20, first, the coefficient calculation section 148 calculates the optimal filter coefficient for each block size (step S22). A subsequent process is performed sequentially on the pixels of interest of the chroma component of the enhancement layer.

The filter control section 147 identifies the block size corresponding to a pixel of interest of the base layer (step S23). Were, the identified block size is typically the size of the CU, the PU, or the TU of the base layer at a position corresponding to a pixel position of the pixel of interest in the enhancement layer.

Then, the filter control section 147 determines whether or not the up-sampling is to be executed based on the pixel position of the pixel of interest and the resolution ratio between the layers (step S25). When the filter control section 147 determines that the up-sampling is to be executed, the reference image acquisition section 143 applies the up-sampling filter to a group of pixels of the base layer buffered by the common memory 2, and acquires a reference pixel value of the pixel of interest (step S27). On the other hand, when the up-sampling is determined not to be executed, the reference image acquisition section 143 acquires the pixel value of the same position of the base layer buffered by the common memory 2 as the reference pixel value of the pixel of interest without change (step S28).

Then, the definition enhancement filter 149 enhances the definition of the chroma component of the pixel of interest by filtering using the chroma component input from the reference image acquisition section 43 and a plurality of neighboring luma components acquired from the luma component buffer 146 as the filter tap (step S32). The filter coefficient set used here is a set corresponding to the block size identified by the filter control section 147.

Then, the definition enhancement filter 149 stores the definition-enhanced reference pixel value of the pixel of interest in the frame memory 25 (step S35). Thereafter, when there is a next pixel of interest, the process returns to step S23 (step S37). On the other hand, when there is no next pixel of interest, the definition-enhancement-associated parameter that may include the filter configuration information indicating the filter configuration of each block size is encoded through the lossless encoding section 16 (step S40), and the process illustrated in FIG. 20 ends.

<5. Configuration Example of EL Decoding Section (Second Embodiment)>

[5-1. Overall Configuration]

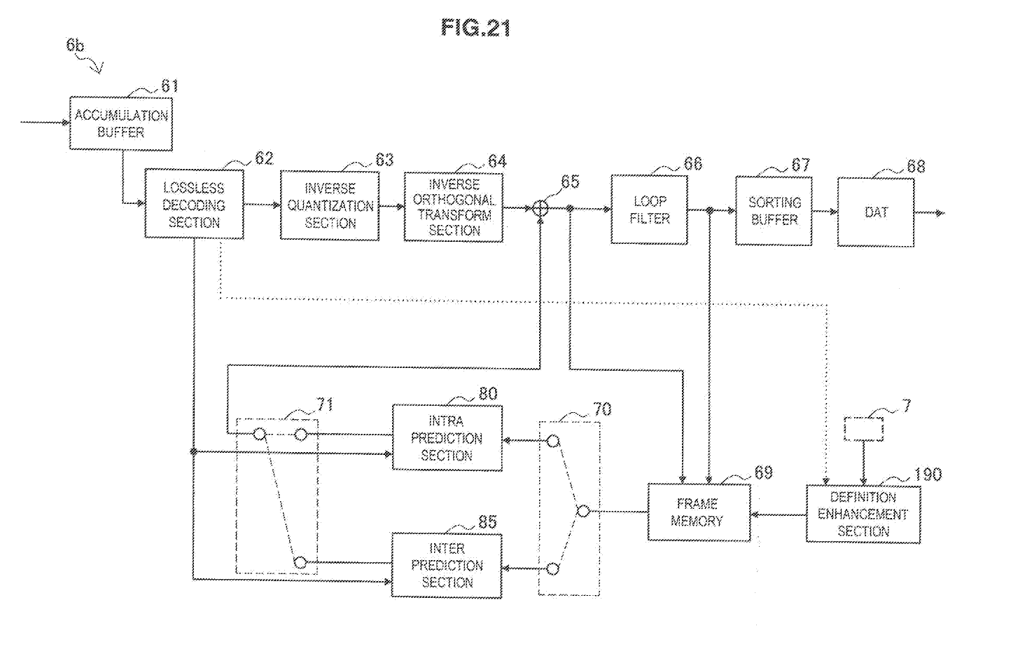

FIG. 21 is a block diagram showing an example of a configuration of an EL decoding section 6b according to the second embodiment. Referring to FIG. 21, the EL decoding section 6b includes an accumulation buffer 61, a lossless decoding section 62, an inverse quantization section 63, an inverse orthogonal transform section 64, an addition section 65, a loop filter 66, a sorting buffer 67, a D/A conversion section 68, a frame memory 69, selectors 70 and 71, an intra prediction section 80, an inter prediction section 85, and a definition enhancement section 190.

The definition enhancement section 190 acquires the image of the base layer buffered by the common memory 7 as the reference image, applies the definition enhancement filter to the acquired reference image, and generates the definition-enhanced reference image. The definition enhancement section 190 controls the application of the definition enhancement filter to the reference image according to the block size of the block set to the image of the base layer. More specifically, in the present embodiment, the definition enhancement section 190 decides a filter configuration of the definition enhancement filter applied to each block depending on the block size of the block. The definition enhancement section 190 also up-samples the reference image when the spatial resolution of the base layer is different from the spatial resolution of the enhancement layer. The definition-enhanced reference image generated by the definition enhancement section 190 may be stored in the frame memory 69 and used as the reference image in the inter-layer prediction by the intra prediction section 80 or the inter prediction section 85. The definition enhancement section 190 controls the definition enhancement process according to the definition-enhancement-associated parameter decoded from the encoded stream.

[5-2. Configuration of Definition Enhancement Section]

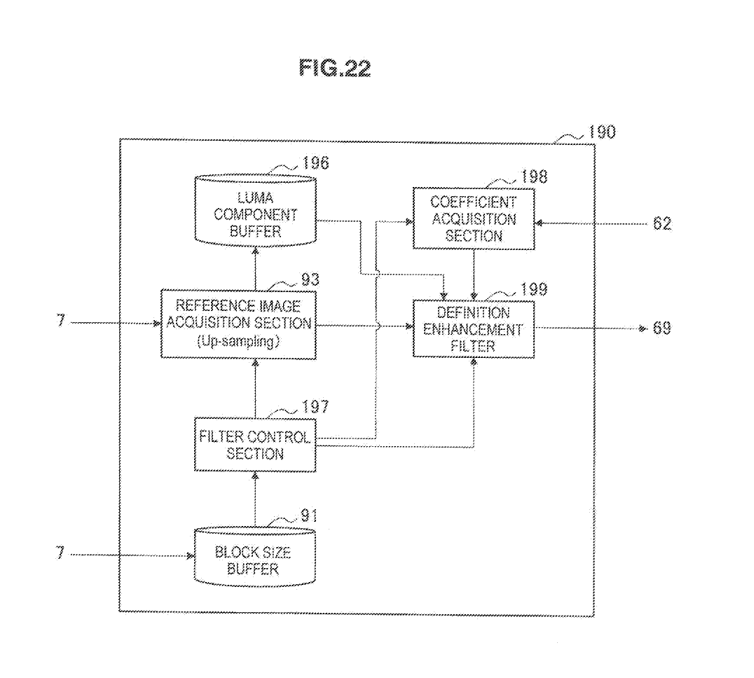

FIG. 22 is a block diagram showing an example of a detailed configuration of the definition enhancement section 190 illustrated in FIG. 21. Referring to FIG. 22, the definition enhancement section 190 includes a block size buffer 91, a reference image acquisition section 93, a luma component buffer 196, a filter control section 197, a coefficient acquisition section 198, and a definition enhancement filter 199.

(1) Luma Component Buffer

The luma component buffer 196 is a buffer that temporarily stores the reference image of the luma component acquired (up-sampled as necessary) by the reference image acquisition section 93. The reference image of the luma component stored by the luma component buffer 196 may be used for the filter operation by the definition enhancement filter 199.

(2) Filter Control Section

The filter control section 197 controls the application of the definition enhancement filter to each of a plurality of blocks of the reference image according to the block size of each block. More specifically, in the present embodiment, the filter control section 197 decides the filter configuration of the definition enhancement filter 199 applied to each block depending on the block size of the block. For example, the filter control section 197 causes the coefficient acquisition section 198 to acquire the filter coefficient set of each block size indicated by the filter configuration information included in the definition-enhancement-associated parameter decoded by the lossless decoding section 62. Further, when the definition enhancement filter 199 is applied to each block, the filter control section 197 causes the definition enhancement filter 199 to use the acquired filter coefficient set corresponding to the block size of the block.

(3) Coefficient Acquisition Section

The coefficient acquisition section 198 acquires the optimal filter coefficient set of the cross color filter applied to the chroma component of the reference image for each block size candidate. Typically, as described above with reference to FIG. 18, the filter coefficient set is calculated at the encoder side and indicated by the filter configuration information decoded by the lossless decoding section 62. The filter configuration information indicates the filter configuration to be used by the definition enhancement filter 199 within a range of an available block size. For example, the filter configuration information may be decoded from the VPS, the SPS, or the PPS of the encoded stream or the extension thereof. The coefficient acquisition section 198 outputs the acquired filter coefficient set of each block size to the definition enhancement filter 199.

For example, when the filter configuration information has undergone the predictive encoding, the coefficient acquisition section 198 acquires the filter coefficient by adding a predicted value of the filter coefficient to a decoded difference value. When the predictive encoding is performed between the pictures, the predicted value of the filter coefficient may be a value of the filter coefficient decoded for a previous picture. When the predictive encoding is performed between different block sizes, a predicted value of the filter coefficient for a certain block size may be a value of the filter coefficient for another block size. When the predictive encoding is performed between different color components, for example, a predicted value of the filter coefficient for the Cr component may be a value of the filter coefficient for the Cb component (and vice versa).

(4) Definition Enhancement Filter

The definition enhancement filler 199 enhances the definition of the reference image used for decoding the image of the enhancement layer having an attribute different from the base layer under control of the filter control section 197. In the present embodiment, the definition enhancement filter 199 may be, for example, the cross color filter proposed in Non-Patent Literature 4. The definition enhancement filter 199 performs the definition enhancement by filtering the chroma components of the reference image input from the reference image acquisition section 93 using the respective chroma components and a plurality of neighboring luma components as the filler tap. The definition enhancement filter 199 uses a set corresponding to the block size identified by the filter control section 197 among a plurality of filter coefficient sets input from the coefficient acquisition section 198. Then, the definition enhancement filter 199 stores the definition-enhanced reference image in the frame memory 69.

[5-3. Process Flow]

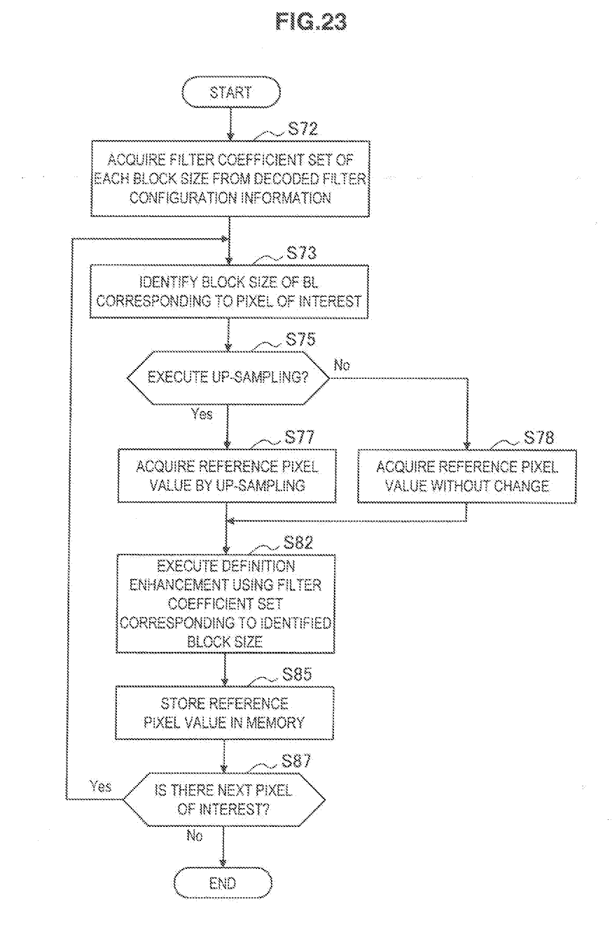

A schematic process flow for decoding according to the present embodiment may be the same as the flow described above with reference to FIG. 14. FIG. 23 is a flowchart showing an example of a process flow associated with the definition enhancement of the reference image for decoding according to the present embodiment.

Referring to FIG. 23, first, the coefficient acquisition section 198 acquires the filler coefficient set of each block size from the filter configuration information decoded by the lossless decoding section 62 (step S72). A subsequent process is performed sequentially on the pixels of interest of the chroma component of the enhancement layer

The filter control section 197 identifies the block size corresponding to a pixel of interest of the base layer (step S73). Here, the identified block size is typically the size of the CU, the PU, or the TU of the base layer at a position corresponding to a pixel position of the pixel of interest in the enhancement layer.

Then, the filter control section 197 determines whether or not the up-sampling is to be executed based on the pixel position of the pixel of interest and the resolution ratio between the layers (step S75). When the filter control section 197 determines that the up-sampling is to be executed, the reference image acquisition section 193 applies the up-sampling filter to a group of pixels of the base layer buffered by the common memory 7, and acquires a reference pixel value of the pixel of interest (step S77). On the other hand, when the up-sampling is determined not to be executed, the reference image acquisition section 193 acquires the pixel value of the same position of the base layer buffered by the common memory 7 as the reference pixel value of the pixel of interest without change (step S78).

Then, the definition enhancement filter 199 enhances the definition of the chroma component of the pixel of interest by filtering using the chroma component input from the reference image acquisition section 93 and a plurality of neighboring luma components acquired from the luma component buffer 196 as the filter tap (step S82). The filter coefficient set used here is a set corresponding to the block size identified by the filter control section 197.

Then, the definition enhancement filter 199 stores the definition-enhanced reference pixel value of the pixel of interest in the frame memory 69 (step S85). Thereafter, when there is a next pixel of interest, the process returns to step S73 (step S87). On the other hand, when there is no next pixel of interest, the process illustrated in FIG. 23 ends.

<6. Example Application>

[6-1. Application to Various Products]

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records image in a medium such as an optical disc, a magnetic disk or a flash memory, a reproduction device that reproduces images from such storage medium, and the like. Four example applications will be described below.

(1) First Application Example

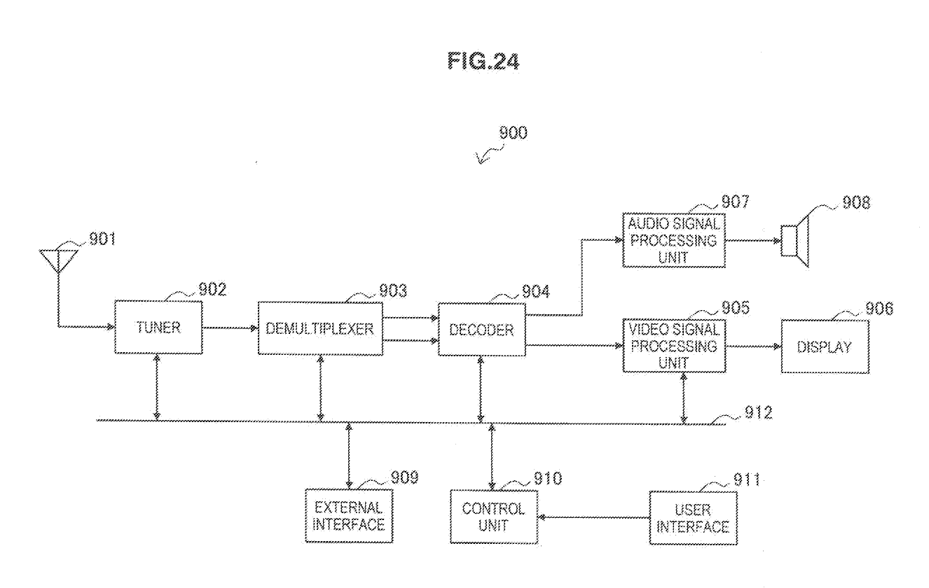

FIG. 24 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910 Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic Electroluminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interlace that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interlace 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. As a result, when the television device 900 enhances the definition of the image referred to between the layers, it is possible to effectively improve the image quality of the reference image while suppressing the operation amount or the code amount.

(2) Second Application Example

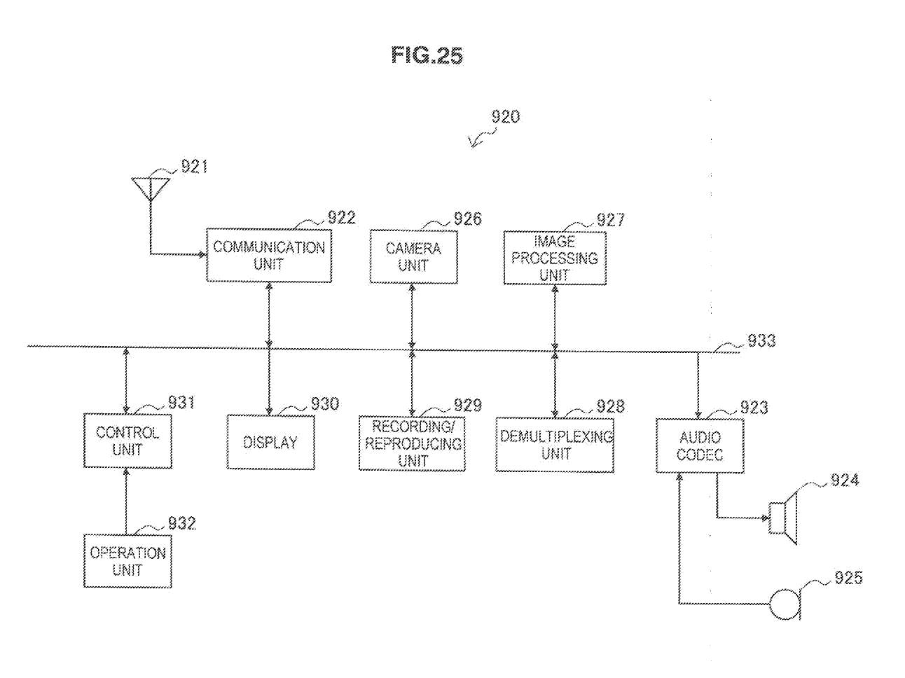

FIG. 25 is a diagram illustrating an example of a schematic configuration of a mobile telephone. A mobile telephone 920 includes an antenna 921, a communication unit 922, an audio codec 923, a speaker 924, a microphone 925, a camera unit 926, an image processing unit 927, a demultiplexing unit 928, a recording/reproduction unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproduction unit 929, the display 930, and the control unit 931.

The mobile telephone 920 performs an operation such as transmitting/receiving an audio signal, transmitting/receiving an electronic mad or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of (be recording/reproducing unit 929.

The recording/reproduction unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the recording/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60. As a result, when the mobile telephone 920 enhances the definition of the image referred to between the layers, it is possible to effectively improve the image quality of the reference image while suppressing the operation amount or the code amount.

(3) Third Application Example

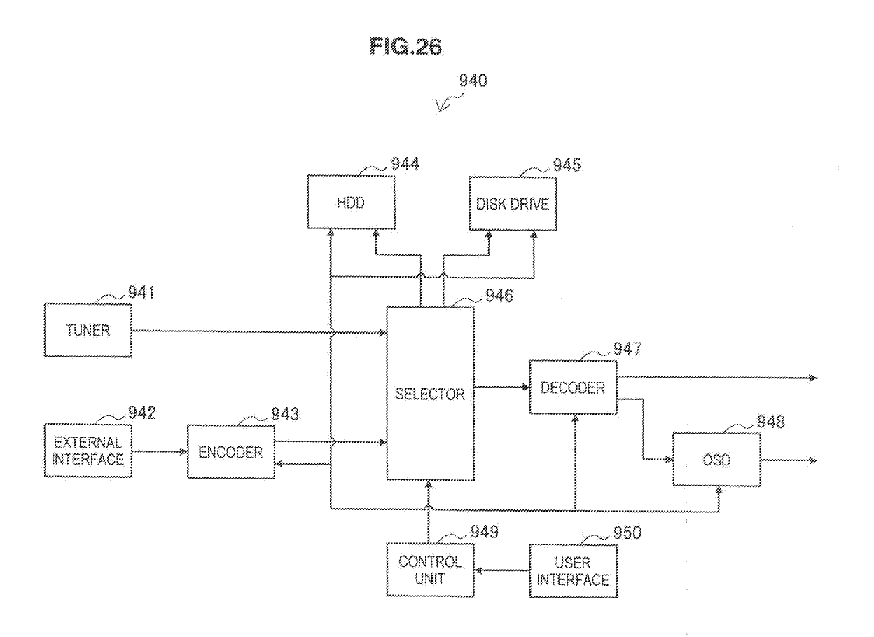

FIG. 26 is a diagram illustrating an example of a schematic configuration of a recording/reproducing device applying the aforementioned embodiment A recording/reproduction device 940 encodes audio data and video data of a broadcast program received and records the data into a recording medium, for example. The recording/reproducing device 940 may also encode audio dam and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 542, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording-reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded hit stream input from the tuner 941 or the encoder 943 when recording the video and audio, and outputs (he selected encoded hit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording-reproducing device 940 and executed, for example. By executing the program, the CPU controls the operation of the recording-reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the linage decoding device 60. As a result, when the recording/reproducing device 940 enhances the definition of the image referred to between the layers, it is possible to effectively improve the image quality of the reference image while suppressing the operation amount or the code amount.

(4) Fourth Application Example

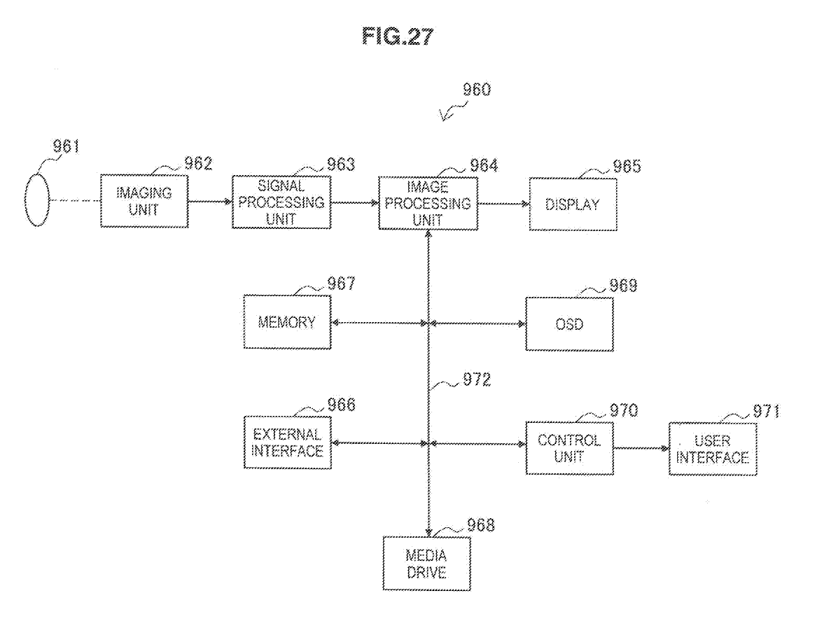

FIG. 27 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal Subsequently, the imaging unit 962 outputs the image signal to the signal processing unit 963.

The signal processing unit 963 performs various camera signal processes such as a knee-correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, tor example. The external interface 966 connects the imaging device 960 with a printer when printing an image, for example. Moreover, a drive is connected to the external interface 966 as needed. A removable medium such as a magnetic disk or an optical disk is mourned to the drive, for example, so that a program read from the removable medium can be installed to the imaging device 960. The external interface 966 may also be configured as a network interface that is connected to a network such as a LAN or the Internet That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mourned to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. As a result, when the imaging device 960 enhances the definition of the image referred to between the layers, it is possible to effectively improve the image quality of the reference image while suppressing the operation amount or the code amount.

[6-2. Various Uses of Scalable Video Coding]

Advantages of scalable video coding described above can be enjoyed in various uses. Three examples of use will be described below.

(1) First Example

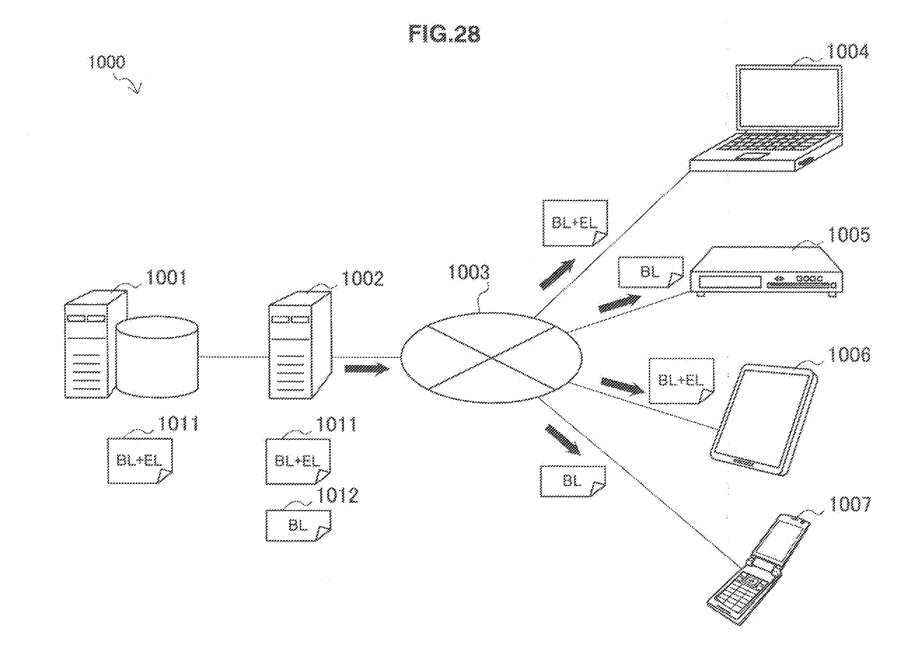

In the first example, scalable video coding is used for selective transmission of data. Referring to FIG. 28, a data transmission system 1000 includes a stream storage device 1001 and a delivery server 1002. The delivery server 1002 is connected to some terminal devices via a network 1003. The network 1003 may be a wire network or a wireless network or a combination thereof. FIG. 28 shows a PC (Personal Computer) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

What a stream is delivered to a terminal device, the delivery server 1002 selects the stream to be delivered based on some condition such as capabilities of a terminal device or the communication environment. For example, the delivery server 1002 may avoid a delay in a terminal device or an occurrence of overflow or overload of a processor by not delivering an encoded stream having high image quality exceeding image quality that can be handled by the terminal device. The delivery server 1002 may also avoid occupation of communication bands of the network 1003 by not delivering an encoded stream having high image quality. On the other hand, when there is no risk 10 be avoided or it is considered to be appropriate based on a user's contract or some condition, the delivery server 1002 may deliver an entire multiplexed stream to a terminal device.

In the example of FIG. 28, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capably of communication at a high communication rate. Because the mobile phone 1007 can communicate at a tow communication rate, the delivery server 1002 delivers the stream data 1012 containing only an encoded stream of the base layer to the mobile phone 1007.

By using the multiplexed stream in this manner, the amount of traffic to be transmitted can adaptively be adjusted. The code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. After generating the stream data 1012 by extracting an encoded stream of the base layer from a received multiplexed stream, the PC 1004 may cause a storage medium to store the stream data 1012 or transfer the stream data to another device.

The configuration of the data transmission system 1000 shown in FIG. 28 is only an example. The data transmission system 1000 may include any numbers of the stream storage device 1001, the delivery server 1002, the network 1003, and terminal devices.

(2) Second Example

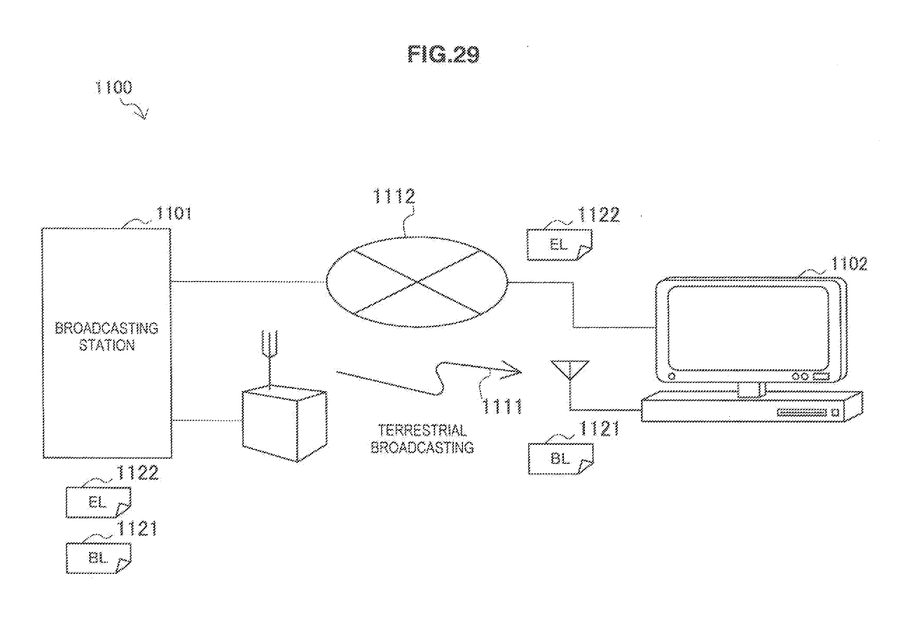

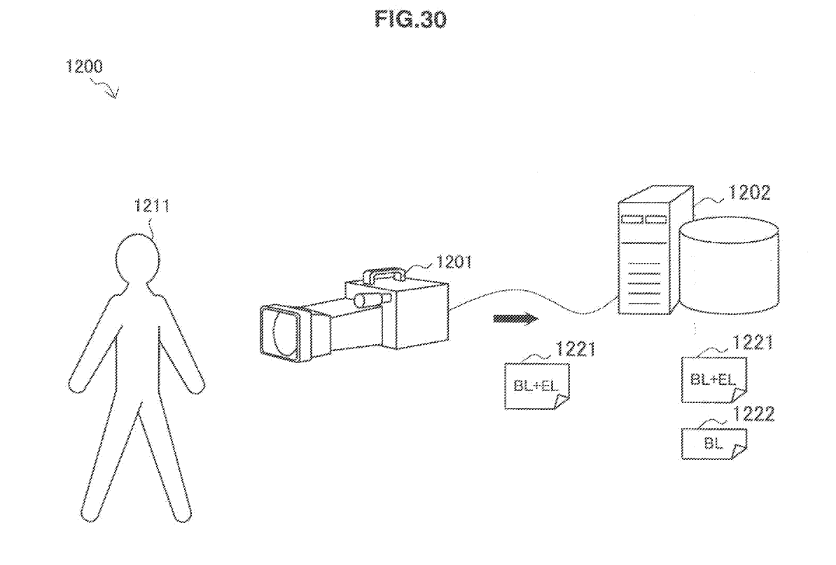

In the second example, scalable video coding is used for transmission of data via a plurality of communication channels. Referring to FIG. 29, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also broadcasts an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. The terminal device 1102 also has a communication function to communicate with the broadcasting station 1101 and receives the encoded stream 1122 of an enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

After receiving the encoded stream 1122 of an enhancement layer via the network 1112, for example, in response to user's instructions, the terminal device 1102 may generate a multiplexed stream by multiplexing the encoded stream 1121 of the base layer and the encoded stream 1122 of an enhancement layer. The terminal device 1102 may also decode an enhancement image from the encoded stream 1122 of an enhancement layer to display the enhancement image on the screen. Alternatively, the terminal device 1302 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be reduced by distributing loads on individual channels.

The communication channel to be used for transmission may dynamically be selected in accordance with some condition. For example, the encoded stream 1121 of the base layer whose data amount is relatively large may be transmitted via a communication channel having a wider bandwidth and the encoded stream 1122 of an enhancement layer whose data amount is relatively small may be transmitted via a communication channel having a narrower bandwidth. The communication channel on which the encoded stream 1122 of a specific layer is transmitted may be switched in accordance with the bandwidth of the communication channel. Accordingly, the load on individual channels can be lessened more effectively.

The configuration of the data transmission system 1100 shown in FIG. 29 is only an example. The data transmission system 1100 may include any numbers of communication channels and terminal devices. The configuration of the system described here may also be applied to other uses than broadcasting.

(3) Third Example

In the third example, scalable video coding is used for storage of video. Referring to FIG. 30, a data transmission system 1200 includes an imaging device 1201 and a stream storage device 1202. The imaging device 1201 scalable-encodes image data generated by a subject 1211 being imaged to generate a multiplexed stream 122). The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in normal mode and stores the extracted encoded stream 1222 of the base layer. In high quality mode, by contrast, the stream storage device 1202 stores the multiplexed stream 1221 as it is. Accordingly, the stream storage device 1202 can store a high-quality stream with a large amount of data only when recording of video in high quality is desired. Therefore, memory resources can be saved while the influence of image degradation on users is curbed.

For example, the imaging device 1201 is assumed to be a surveillance camera. When no surveillance object (for example, no intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). In contract, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 30, the mode is selected by the stream storage device 1202 based on, for example, an image analysis result However, the present embodiment is not limited to such an example and the imaging device 1201 may select the mode. In the latter case, imaging device 1201 may supply the encoded stream 1222 of the base layer to the stream storage device 1202 in normal mode and the multiplexed stream 1221 to the stream storage device 1202 in high-quality mode.

Selection criteria for selecting the mode may be any criteria. For example, the mode may be switched in accordance with the loudness of voice acquired through a microphone or the waveform of voice. The mode may also be switched periodically. Also, the mode may be switched in response to user's instructions. Further, the number of selectable modes may be any number as long as the number of hierarchized layers is not exceeded.

The configuration of the data transmission system 1200 shown in FIG. 30 is only an example. The data transmission system 1200 may include any number of the imaging device 1201. The configuration of the system described here may also be applied to other uses than the surveillance camera.

[6-3. Others]

(1) Application to the Multi-View Codec

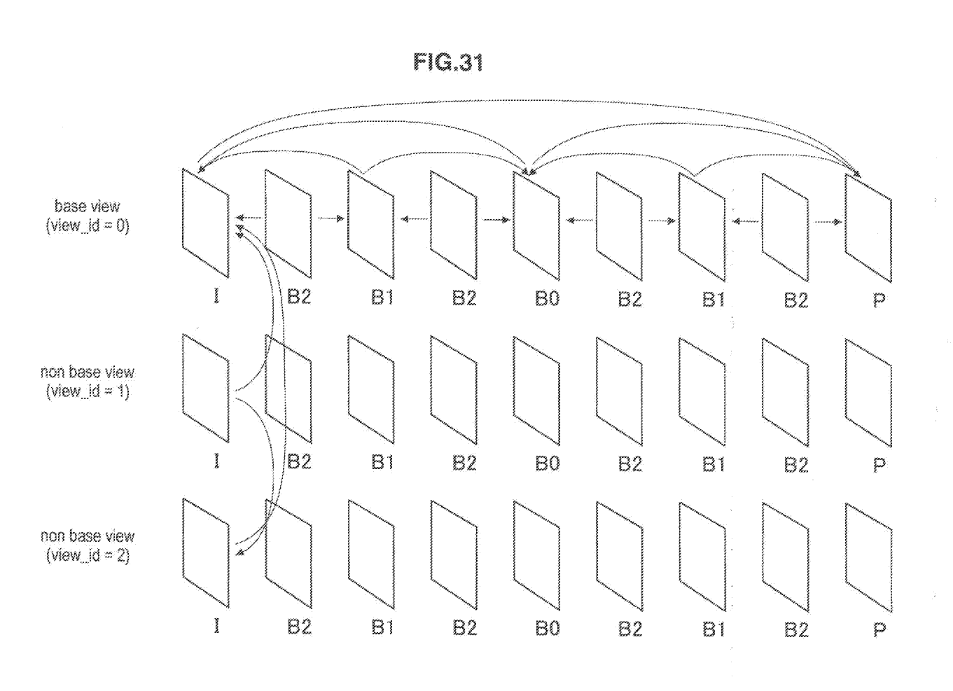

The multi-view codec is a kind of multi-layer codec and is an image encoding system to encode and decode so-called multi-view video. FIG. 31 is an explanatory view illustrating a multi-view codec. Referring to FIG. 31, sequences of three view frames captured from three viewpoints are shown A view ID (view_id) is attached to each view. Among a plurality of these views, one view is specified as the base view. Views other than the base view are called non-base views. In the example of FIG. 21, the view whose view ID is “0” is the base view and two views whose view ID is “1” or “2” are non-base views. When these views are hierarchically encoded, each view may correspond to a layer. As indicated by arrows in FIG. 31, an image of a non-base view is encoded and decoded by referring to an image of the base view (an image of the other non-base view may also be referred to).

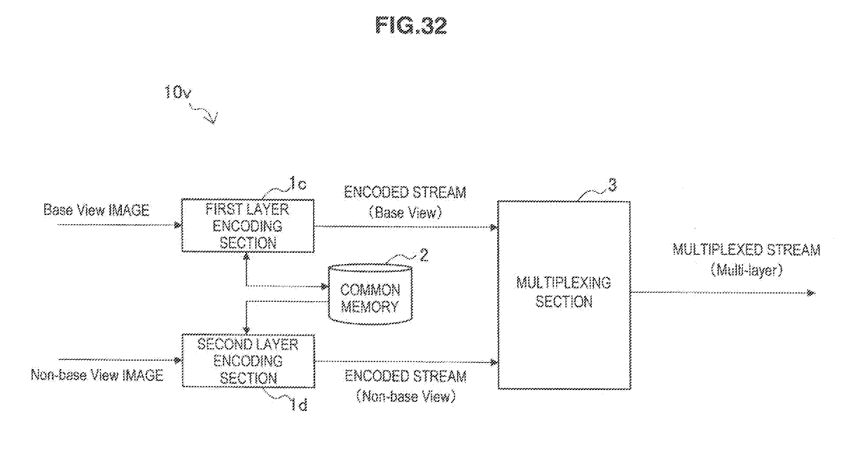

FIG. 32 is a block diagram showing a schematic configuration of an image encoding device 10v supporting the multi-view codec. Referring to FIG. 32, the image encoding device 10v includes a first layer encoding section 1c, a second layer encoding section 1d, the common memory 2, and the multiplexing section 3.

The function of the first layer encoding section 1c is the same as that of the BL encoding section 1a described using FIG. 5 except that, instead of a base layer image, a base view image is received as input. The first layer encoding section 1c encodes the base view image to generate an encoded stream of a first layer. The function of the second layer encoding section 1d is the same as that of the EL encoding section 1b described using FIG. 3 except that, instead of an enhancement layer image, a non-base view image is received as input. The second layer encoding section 1d encodes the non-base view image to generate an encoded stream of a second layer. The common memory 2 stores information commonly used between layers. The multiplexing section 3 multiplexes an encoded stream of the first layer generated by the first layer encoding section 1c and an encoded stream of the second layer generated by the second layer encoding section 1d to generate a multilayer multiplexed stream.

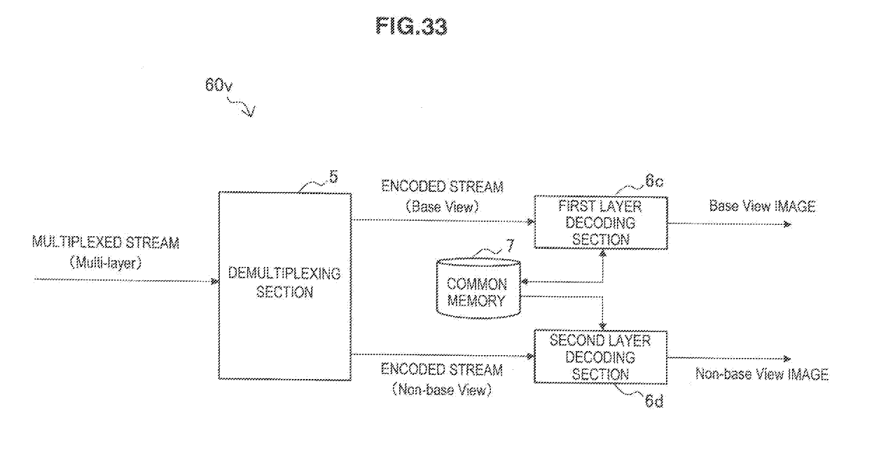

FIG. 33 is a block diagram showing a schematic configuration of an image decoding device 60v supporting the multi-view codec. Referring to FIG. 33, the image decoding device 60v includes the demultiplexing section 5, a first layer decoding section 6c, a second layer decoding section 6d, and the common memory 7.

The demultiplexing section 5 demultiplexes a multilayer multiplexed stream into an encoded stream of the first layer and an encoded stream of the second layer. The function of the first layer decoding section 6c is the same as that of the BL decoding section 6a described using FIG. 4 except that an encoded stream in which, instead of a base layer image, a base view image is encoded is received as input. The first layer decoding section 6c decodes a base view image from an encoded stream of the first layer. The function of the second layer decoding section 6d is the same as that of the EL decoding section 6b described using FIG. 4 except that an encoded stream in which, instead of an enhancement layer image, a non-base view image is encoded is received as input. The second layer decoding section 6d decodes a non-base view image from an encoded stream of the second layer. The common memory 7 stores information commonly used between layers.

When multi-view image data is encoded or decoded and the spatial resolution is different between views, definition enhancement of an image referred to between layers may be controlled according to the technology in the present disclosure. As a result, similarly to the case of the scalable video coding, it is possible to efficiently improve the image quality of the reference image while suppressing the operation amount or the code amount.

(2) Application to Streaming Technology

Technology in the present disclosure may also be applied to a streaming protocol. In MPEG-DASH (Dynamic Adaptive Streaming over HTTP), for example, a plurality of-encoded streams having mutually different parameters such as the resolution is prepared by a stream server in advance. Then, the streaming server dynamically selects appropriate data for streaming from the plurality of encoded streams and delivers the selected data. In such a streaming protocol, the definition enhancement of the reference image referred to between the encoded streams may be controlled according to the technology of the present disclosure.

<7. Conclusion>

Various embodiments of the technology of the present disclosure have been described above with reference to FIGS. 1 to 33. According to the above embodiments, the application of the definition enhancement filter to a reference image that is used for encoding or decoding an image of a second layer and based on a decoded image of a first layer is controlled according to a block size of a block in the first layer. Thus, it is possible to efficiently improve the image quality of the reference image through the definition enhancement filter using a correlation between the block size (for example, the CU size, the PU size, or the TU size) and the strength of the high-frequency component.

For example, according to the first embodiment, the application of the definition enhancement filter to the block having the block size larger than the threshold value is invalidated. As a result, the filtering operation amount is reduced. Further, it is possible to reduce the power consumption of the encoder and the decoder. Since an image of a block having a large block size tends to be close to a flat region, the loss of the image quality is still small when the application of the definition enhancement filter to the block having the large block size is invalidated.

Further, according to the second embodiment, the filter configuration of the definition enhancement filter applied to each block is decided depending on the block size of the block. In this case, since only one filter coefficient set need be transmitted from the encoder to the decoder for each block size candidate, it is possible to reduce the code amount of the filter configuration information specifying the filter coefficient to be smaller than in the implementation in which the filter coefficient is decided for each block. Further, it is possible to adaptively improve the image quality according to the strength of the high-frequency component of each image region compared to the implementation in which the single filter coefficient is used.

The first embodiment and the second embodiment may be combined with each other. In this case, for example, the application of the definition enhancement filter to the block having the block size larger than the determination threshold value is invalidated, and the filter configuration of the definition enhancement filter applied to the blocks having other block sizes is decided depending on the block size. Further the technology according to the present disclosure is not limited to an application of the space scalability scheme, the SNR scalability scheme, or a combination thereof. For example, when the technology according to the present disclosure is applied to the bit depth scalability scheme, the bit shift operation may be executed when the reference image is acquired.

The terms “CU,” “PU,” and “TU” described in the present specification refer to logical units including a syntax associated with an individual block in HEVC. When only individual blocks which are parts of an image are focused on, the blocks may be referred to with the terms “coding block (CB),” “prediction block (PB),” and “transform block (TB).” A CB is formed by hierarchically dividing a coding tree block (CTB) in a quad-tree shape. The one entire quad-tree corresponds to the CTB and a logical unit corresponding to the CTB is referred to as a coding tree unit (CTU). The CTB and the CB in HEVC have a similar role to a macro block in H.264/AVC in that the CTB and the CB are processing units of an encoding process. However, the CTB and the CB are different from the macro block in that the sizes of the CTB and the CB are not fixed (the size of the macro block is normally 16×16 pixels). The size of the CTB is selected from a size of 16×16 pixels, a size of 32×32 pixels, and a size of 64×64 pixels and is designated by a parameter in an encoded stream. The size of the CB can be changed according to a division depth of the CTB.

Mainly described herein is the example where the various pieces of information such as the information related to control of definition enhancement are multiplexed to the header of the encoded stream and transmitted from the encoding-side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

In addition, the effects described in the present specification are merely illustrative and demonstrative, and not limitative. In other words, the technology-according to the present disclosure can exhibit other effects that are evident to those skilled in the art along with or instead of the effects based on the present specification.

Additionally, the present technology may also be configured as below.

(1)

An image processing apparatus, including:

an acquisition section configured to acquire a reference image used for encoding or decoding an image of a second layer having 3 different attribute from a first layer, the reference image being based on a decoded image of the first layer in which a plurality of blocks having different block sizes are set;

a filtering section configured to apply a definition enhancement filter to the reference image acquired by the acquisition section and generate a definition-enhanced reference image; and

a control section configured to control an application of the definition enhancement filter to each of the plurality of blocks by the filtering section according to a block size of each of the blocks.

(2)

The image processing apparatus according to (1), wherein the block is set as a processing unit of an encoding process for the first layer.

(3)

The image processing apparatus according to (1), wherein the block is set as a processing unit of a prediction process for the first layer.

(4)

The image processing apparatus according to (1),

wherein the block is set as a processing unit of an orthogonal transform process for the first layer.

(5)

The image processing apparatus according to any one of (1) to (4),

wherein the control section invalidates the application of the definition enhancement filter to a block having a block size larger than a threshold value.

(6)

The image processing apparatus according to (5),

wherein the control section deckles the threshold value depending on a spatial resolution ratio between the first layer and the second layer.

(7)

The image processing apparatus according to (5), further including

a decoding section configured to decode threshold value information indicating the threshold value from an encoded stream.

(8)

The image processing apparatus according to (5), further including

an encoding section configured to encode threshold value information indicating the threshold value to an encoded stream.

(9)

The image processing apparatus according to any one of (1) to (4),

wherein the control section decides a filter configuration of the definition enhancement filter applied to each of the blocks depending on the block size of the block.

(10)

The image processing apparatus according to (9), further including

a decoding section configured to decode filter configuration information indicating the filter configuration to be used for each block size from an encoded stream.

(11)

The image processing apparatus according to (9), further including

an encoding section configured to encode filter configuration information indicating the filter configuration to be used for each block size to an encoded stream.

(12)

The image processing apparatus according to (10) or (11),

wherein the filter configuration information indicates the filter configuration for each block size within a range of an available block size.

(13)

The image processing apparatus according to any one of (10) to (12),

wherein the filter configuration information includes information that undergoes predictive encoding between pictures, different block sizes, or different color components.

(14)

The image processing apparatus according to any one of (10) to (13),

wherein the filter configuration information indicates an optimal filter configuration calculated at the time of encoding using a pixel value of one or more blocks having the corresponding block size for each block size.

(15)

The image processing apparatus according to any one of (1) to (14).

wherein the definition enhancement filter is a cross color filter that enhances, a definition of a chroma component based on n neighboring luma component.

(16)

The image processing apparatus according to any one of (1) to (8),

wherein the definition enhancement filter is an edge enhancement filter.

(17)

The image processing apparatus according to any one of (1) to (16),

wherein the acquisition section acquires the reference image by up-sampling the decoded image of the first layer having a lower spatial resolution than the second layer.

(18)

The image processing apparatus according to any one of (1) to (17),

wherein the acquisition section acquires the decoded image of the first layer having a larger quantization error than the second layer as the reference image.

(19)

An image processing method, including:

acquiring a reference image used for encoding or decoding an image of a second layer having a different attribute from a first layer, the reference image being based on a decoded image of the first layer in which a plurality of blocks having different block sizes are set;

applying a definition enhancement filter to the acquired reference image arid generating a definition-enhanced reference image; and

controlling an application of the definition enhancement filter to each of the plurality of blocks according to a block size of each of the blocks.

### REFERENCE SIGNS LIST

10, 10v image encoding device (image processing apparatus)
16 lossless encoding section
43 reference image acquisition section
47, 147 filter control section
49, 149 definition enhancement filter (filtering section)
60, 60v image decoding device (image processing apparatus)
62 lossless decoding section
93 reference image acquisition section
97, 197 filter control section
99, 199 definition enhancement filter (filtering section)

1. An image processing apparatus, comprising:
an acquisition section configured to acquire a reference image used for encoding or decoding an image of a second layer having a different attribute from a first layer, the reference image being based on a decoded image of the first layer in which a plurality of blocks having different block sizes are set;
a filtering section configured to apply a definition enhancement filter-to the reference image acquired by the acquisition section and generate a definition-enhanced reference image; and
a control section configured to control an application of the definition enhancement filter to each of the plurality of blocks by the filtering section according to a block size of each of the blocks.

2. The image processing apparatus according to claim 1,
wherein the block is set as a processing unit of an encoding process for the first layer.

3. The image processing apparatus according to claim 1,
wherein the block is set as a processing unit of a prediction process for the first layer.

4. The image processing apparatus according to claim 1,
wherein the block is set as a processing unit of an orthogonal transform process for the first layer.

5. The image processing apparatus according to claim 1,
wherein the control section invalidates the application of the definition enhancement filter to a block having a block size large, than a threshold value.

6. The image processing apparatus according to claim 5,
wherein the control section decides the threshold value depending on a spatial resolution ratio between the first layer and the second layer.

7. The image processing apparatus according to claim 5, further comprising
a decoding section configured to decode threshold value information indicating the threshold value from an encoded stream.

8. The image processing apparatus according to claim 5, further comprising
an encoding section configured to encode threshold value information indicating the threshold value to an encoded stream.

9. The image processing apparatus according to claim 1,
wherein the control section decides a filter configuration of the definition enhancement filter applied to each of the blocks depending on the block size of the block.

10. The image processing apparatus according to claim 9, further comprising
a decoding section configured to decode filter configuration information indicating the filter configuration to be used for each block size from an encoded stream.

11. The image processing apparatus according to claim 9, further comprising
an encoding section configured to encode filler configuration information indicating the filter configuration to be used for each block size to an encoded stream.

12. The image processing apparatus according to claim 10,
wherein the filter configuration information indicates the filter configuration for each block size within a range of an available block size.

13. The image processing apparatus according to claim 10,
wherein the filter configuration information includes information that undergoes predictive encoding between pictures, different block sizes, or different color components.

14. The image processing apparatus according to claim 10,
wherein the filter configuration information indicates an optimal filter configuration calculated at the time of encoding using a pixel value of one or more blocks having the corresponding block size for each block size.

15. The image processing apparatus according to claim 1,
wherein the definition enhancement filter is a cross color filter that enhances a definition of a chroma component based on a neighboring luma component.

16. The image processing apparatus according to claim 1.
wherein the definition enhancement filter is an edge enhancement filter.

17. The image processing apparatus according to claim 1,
wherein the acquisition section acquires the reference image by up-sampling the decoded image of the first layer having a lower spatial resolution than the second layer.

18. The image processing apparatus according to claim 1,
wherein the acquisition section acquires the decoded image of the first layer having a larger quantization error than the second layer as the reference image.

19. An image processing method, comprising:
acquiring a reference image used for encoding or decoding an image of a second layer having a different attribute from a first layer, the reference image being based on a decoded image of the first layer in which a plurality of blocks having different block sizes are set;
applying a definition enhancement filter to the acquired reference image and generating a definition-enhanced reference image; and
controlling an application of the definition enhancement filter to each of the plurality of blocks according to a block size of each of the blocks.
